(19) United States
(12) Patent Application Publication
(10) Pub. No.: US 2025/0348740 A1
(43) Pub. Date: Nov. 13, 2025

(54) AN END-TO-END APPROACH TO DETERMINING HIGH-QUALITY DIGITAL CONTENT RECOMMENDATIONS

(71) Applicant: Microsoft Technology Licensing, LLC, Redmond, WA (US)

(72) Inventors: Chujie Zheng, Newark, CA (US); Jeffrey Wang, San Francisco, CA (US); Shuqian Zhang, Cupertino, CA (US); Siddharth Pratap Singh, Fremont, CA (US); Anand Kishore, San Jose, CA (US)

(21) Appl. No.: 18/660,482

(22) Filed: May 10, 2024

(51) Int. Cl. G06N 3/0895; G06F 16/2457

(52) U.S. Cl. CPC G06N 3/0895; G06F 16/24575

(57) ABSTRACT

Embodiments of the disclosed technologies are capable of evaluating content recommendations. The embodiments describe creating a prompt using a search query and a content recommendation output by a machine learning model in response to the search query. The embodiments further describe causing a LLM to generate an evaluation of the content recommendation and the search query using the prompt. The evaluation includes a relevance score of the content recommendation and the search query. The embodiments further describe training the machine learning model to generate an updated content recommendation in response to the search query. The training includes using the relevance score of the content recommendation and the search query.

### TECHNICAL FIELD

Embodiments of the invention relate to the field of digital content recommendations.

### BACKGROUND

A recommendation engine is a software program that helps people find information online. A user provides search query terms through a search interface. When the user is finished providing the search query terms, the user inputs a signal that tells the search engine to initiate the search. In response to the initiate search signal, the recommendation engine formulates a search based on the input provided by the user prior to the initiate search signal, executes the search to retrieve information related to the search query terms, and provides the retrieved information as a content recommendation to the search interface.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for evaluating content recommendations during an offline inference period, in accordance with some embodiments of the present disclosure.

FIG. 2 is an example of a prompt used to instruct a machine learning model to evaluate content recommendations, in accordance with some embodiments of the present disclosure.

FIG. 3 illustrates an example architecture of a machine learning model, in accordance with some embodiments of the present disclosure.

FIG. 4 is a flow diagram of an example method for training a recommendation engine using supervised learning, in accordance with some embodiments of the present disclosure.

FIG. 5 is a flow diagram of generating OTR scores for use as training data using a student-teach framework, in accordance with some embodiments of the present disclosure.

FIG. 6 is a flow diagram of an example method for evaluating multiple content recommendations, in accordance with some embodiments of the present disclosure.

FIG. 7 is a block diagram of a computing system that includes a content recommendation evaluator and a training manager, in accordance with some embodiments of the present disclosure.

FIG. 8 is an example of an entity graph, in accordance with some embodiments of the present disclosure.

FIG. 9 is a flow diagram of an example method for evaluating content recommendations, in accordance with some embodiments of the present disclosure.

FIG. 10 is a block diagram of an example computer system including a content recommendation evaluator and a training manager, in accordance with some embodiments of the present disclosure.

### DETAILED DESCRIPTION

Responsive to receiving a search query, a recommendation engine ranks results of the search query in a rank order according to a ranking score, where the search result with the highest-ranking score is presented as the first item in a list (e.g., at the top of the list) and search results with lower ranking scores are presented further down in the list. The position of an item of a search result in a user interface relative to other items of the search result often corresponds to the ranking score of the item. Examples of search results include digital content items, such as documents, videos, audio files, digital images, and web pages, such as entity profile pages.

In an embodiment, at least some portions of a content ranking process are performed by a machine learning model. The machine learning model uses a “learning-to-rank” algorithm to learn a function that assigns a score to one or more content recommendations responsive to the search query. The machine learning model can be trained to perform a target task by relying on patterns and inferences learned from training data, without requiring explicit instructions pertaining to how the task is to be performed.

Supervised learning is a method of training a machine learning model given input-output pairs. An input-output pair is an input with an associated known output (e.g., an expected output, a labeled output, a ground truth). During a training period, a machine learning model iteratively develops statistical correlations used to perform a task (such as determine one or more content recommendations, determine a ranking score for the content recommendations, and in some instances, rank the content recommendations) by receiving training samples included as a training input (e.g., the input of the input-output pair). The machine learning model then predicts an output (e.g., content recommendations and corresponding ranking scores used to rank the content recommendations) by identifying one or more digital content items with the highest confidence scores or probabilities and compares the predicted output to the known output associated with the training input (e.g., the output of the input-output pair, or the ranked content recommendations). For example, to train a machine learning model to determine a ranking score of a content recommendation, the training input can include a search query and the training output can include one or more content recommendations and a corresponding ranking score. Over time, (e.g., a number of training iterations), an error based on the difference between the predicted output and the known output decreases.

A generative model uses artificial intelligence technology, e.g., neural networks, to machine-generate new digital content based on model inputs and the previously existing data with which the model has been trained. Whereas discriminative models are based on conditional probabilities P (y|x), that is, the probability of an output y given an input x (e.g., is this a photo of a dog?), generative models capture joint probabilities P (x, y), that is, the likelihood of x and y occurring together (e.g., given this photo of a dog and an unknown person, what is the likelihood that the person is the dog's owner, Sam?).

A generative language model is a particular type of generative model that generates new text in response to model input. The model input includes a task description, also referred to as a prompt. A prompt can be in the form of natural language text, such as a question or a statement, and can include non-text forms of content, such as digital imagery and/or digital audio. The prompt can include instructions and/or examples of content used to explain the task that the generative model is to perform. Modifying the instructions, examples, content, and/or structure of the prompt causes modifications to the output of the model. For example, changing the instructions included in the prompt causes changes to the generated content determined by the model.

Prompt engineering is a technique used to optimize the structure and/or content of the prompt input to the generative model. Some prompts can include examples of outputs to be generated by the generative model (e.g., few-shot prompts), while other prompts can include no examples of outputs to be generated by the generative model (e.g., zero-shot prompts). Chain of thought prompting is a prompt engineering technique where the prompt includes a request that the model explain reasoning in the output. For example, the generative model performs the task provided in the prompt using intermediate steps where the generative model explains the reasoning as to why it is performing each step.

A large language model (LLM) is a type of generative language model that is trained using an abundance of data (e.g., publicly available data) such that billions of hyperparameters that define the LLM are used to learn a task.

Inference time can be a time period other than the training period in which the machine learning model is deployed or otherwise executed. For example, the machine learning model can be deployed to perform the target task for which it was trained (e.g., determine a content recommendation and corresponding ranking score using a search query). Inference time can include both an online inference period (e.g., a time period in which the machine learning model is deployed in furtherance of ranking content recommendations responsive to an active user search query) and an offline inference period (e.g., a time period in which the machine learning model is deployed in furtherance of ranking content recommendations responsive to a stored user search query).

A content recommendation can be a high-quality content recommendation or a low-quality content recommendation. A high-quality content recommendation is a content recommendation that includes one or more topics referred to in a search query and can match a user search intent (e.g., the content recommendation is a personalized). A topic can be referred to in a search query if the topic is explicitly described in the search query (e.g., using string matching) and/or is semantically related to the search query. In some cases, a content recommendation is a high-quality content recommendation given a threshold amount of content in the search query that matches (or is semantically similar) to content in the digital content item. For example, a threshold number of semantically similar tokens are identified in both the digital content item and the search query. A low-quality content recommendation is a content recommendation that does not refer to a topic in the search query, does not include a topic that is relevant to a user based on a user search intent, or some combination. In some cases, a high-quality content recommendation can receive a high ranking score and a low-quality content recommendation can receive a low ranking score.

For example, suppose a search query of “Alex” is input by a first user, and the first user search intent is to search for profile information about a person named “Alex V.” In this example, a high-quality content recommendation would be a user profile of a person named “Alex V” (because the content recommendation matches the user's intent of searching for a person) and a low-quality content recommendation would be an article about a product called “Alexa” (because the content recommendation associated with a product does not match the user's intent to search for a person). As another example, suppose a search query of “Alex” is input by a second user, and the second user's search intent is to search for a product called “Alexa.” In this example, a high-quality content recommendation would be an article about a product called “Alexa” (because the content recommendation matches the user's intent of searching for a product) and a low-quality content recommendation would be a user profile of a person named “Alex V” (because the content recommendation associated with a person does not match the user's intent to search for a product).

Sometimes a user search intent is not considered in evaluating whether a content recommendation is high-quality or low-quality. That is, a high-quality content recommendation can be a content recommendation that refers to one or more topics included in a search query and a low-quality content recommendation can be a content recommendation that does not refer to a topic included in the search query.

Low-quality content recommendations distract users from their true search intent and decrease the user experience. Additionally, low-quality content recommendations waste computing resources associated with searching for and scoring irrelevant content recommendations or re-obtaining content recommendations and re-ranking the content recommendations based on re-running a search query to improve the results of the search query (e.g., to obtain high-quality content recommendations). In contrast, high-quality content recommendations improve the search ecosystem by increasing a user experience through increased searcher engagement and by increasing downstream activities. Downstream activities are related to user engagement. Examples of such downstream activities include interacting with a content recommendation, adding a user profile to a list of profiles (e.g., connecting with the user profile, following the user profile, saving the user profile), sending a message to a user, saving a user profile, purchasing a product, or downloading digital content.

In some cases, there may be differences in the inputs received by the machine learning model during the training period and the inference period. For example, the inputs provided to the machine learning model during the training period or the offline inference period can be search queries of a first type. Because the search queries are input to the machine learning model during the training period and the offline inference period, the search queries of the first type are stored search queries. In contrast, the inputs provided to the machine learning model during the online inference period can be search queries of a second type. Because the search queries are input to the machine learning model during the online inference period, the search queries of the second type are active search queries. That is, the active search queries can be a different type of search query than the stored search queries (e.g., the search queries of the first type are different from the search queries of the second type).

In a non-limiting example, search queries of the first type can be search queries associated with user profiles, and search queries of the second type can be search queries associated with current events. In the non-limiting example, the search queries of the first type can be static. That is, a content recommendation responsive to a search query for user A at a first time period and a second time period will be the same. For example, a content recommendation of User Profile A can be a high-quality content recommendation at the first timer period and the second time period. In contrast, the search queries of the second type can be dynamic. That is, a high-quality content recommendation responsive to a search query for Current Events at a first time period may not be the same as a high-quality content recommendation responsive to the search query for Current Events at a second time period by virtue of the dynamic nature of the search query (e.g., what is current at the first time period may be different from what is current at the second time period). For example, a content recommendation of Article 1 dated Time 1 can be a high-quality content recommendation associated with a search query corresponding to Time 1, however the content recommendation of Article 1 dated Time 1 can be a low-quality content recommendation associated with a search query corresponding to Time 2.

In another non-limiting example, search queries of the first type can be search queries for content using a sentence format, and search queries of the second type can be search queries for content using keywords. In this non-limiting example, the active search queries (e.g., search queries of the second type passed to the machine learning model during the online inference period) capture an evolving style of user search query inputs. That is, while users previously entered search queries in a natural language format (e.g., resulting in stored search queries of the first type used during the training period and/or offline inference period), users currently enter search queries using less contextual information than the previous search queries (e.g., keywords versus natural language format), represented by the active search queries of the second type.

The technical difficulties associated with the differences of the types of data input during the online inference period and the training period and/or offline inference period can cause problems such as determining ranking scores differently during the online inference period and the training period and/or offline inference period. Such different determinations of ranking scores can result in ranking content recommendations that are low-quality content recommendations higher than content recommendations that are high-quality content recommendations during the online inference period. That is, the patterns and inferences associated with search queries of the first type that are used to develop statistical correlations for the machine learning model during the training data period and/or offline inference period are different from the patterns and inferences associated with search queries of the second type input to the machine learning model during the online inference period. Accordingly, the ranking score determined by the machine learning model during the online inference period and during the offline inference period and/or training period are different, causing a performance gap (e.g., the machine learning model performs well during the training period and/or offline inference period and the machine learning model performs poorly during the online inference period).

Thus, a technical challenge is for recommendation engines to determine high-quality content recommendations based on the search query during both the training period and inference period (including both the offline inference period and online inference period). Conventional methods that evaluate the quality of content recommendations during the online inference period to ensure the recommendation engine is accurately ranking content recommendations (based on identifying high-quality content recommendations using high ranking scores, for instance) can cause delays and consume extraneous resources associated with re-evaluating the quality of each content recommendation ranked by the machine learning model. Accordingly, aspects of the present disclosure address the above challenges and other deficiencies using an end-to-end approach for determining high-quality content recommendations during an offline inference period. The end-to-end approach minimizes gaps in performance between the online inference period and the offline inference period and/or training period. That is, the end-to-end approach minimizes the differences in how ranking scores are determined during the online inference period.

In operation, an on-topic-rate (OTR) score is determined for each content recommendation that enables the machine learning model to identify high-quality and low-quality content recommendations. Aspects of the present disclosure evaluate the performance of the machine learning model using the OTR score of one or more content recommendations given a diverse set of input types from multiple datasets. The diverse set of input types from multiple datasets mimics the online inference period. The OTR score of the content recommendations is used to modify an aspect of the machine learning model (e.g., the output of the machine learning model, the input of the machine leaning model, the training data of the machine learning model, or some combination).

The disclosed technologies are described in the context of a search system of an online network-based application software system. For example, news and entertainment apps installed on mobile devices, messaging systems, and social graph-based applications can all function as application software systems that include search systems. An example of a search use case is a user of an online system searching for job candidates via job candidate user profiles over a professional social network that includes information about companies, job postings, and users of the online system.

Aspects of the disclosed technologies are not limited to social network applications but can be used to improve search systems more generally. The disclosed technologies can be employed by many different types of network-based applications in which a search interface is provided, including but not limited to various types and forms of application software systems.

The disclosure will be understood more fully from the detailed description given below, which references the accompanying drawings. The detailed description of the drawings is for explanation and understanding and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains but can be used with or incorporated into other embodiments, including embodiments shown in other drawings.

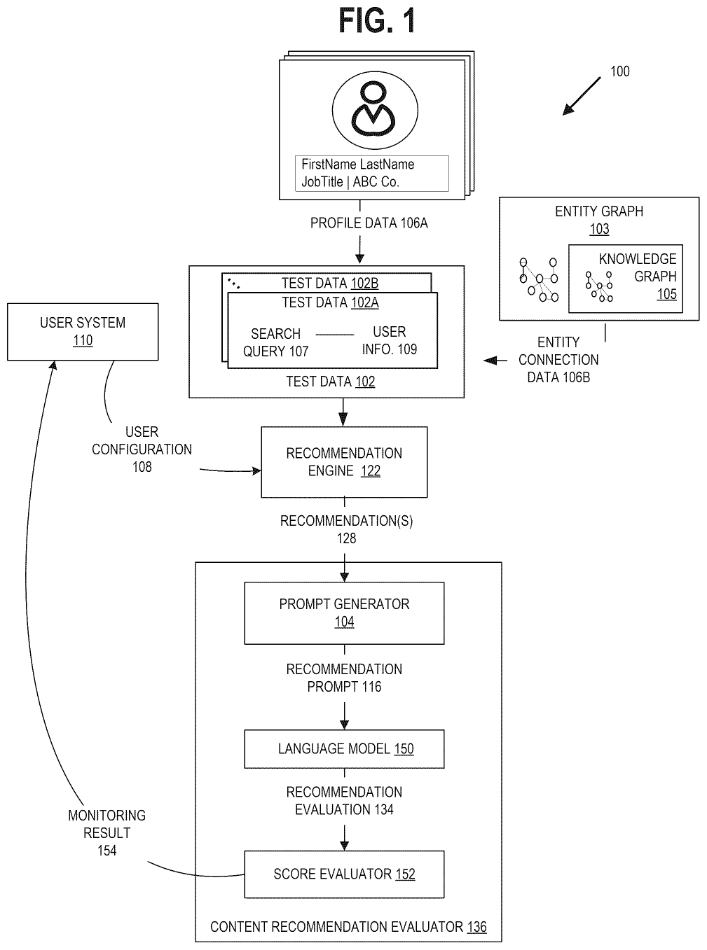

FIG. 1 is a flow diagram of an example method for evaluating content recommendations during an offline inference period, in accordance with some embodiments of the present disclosure.

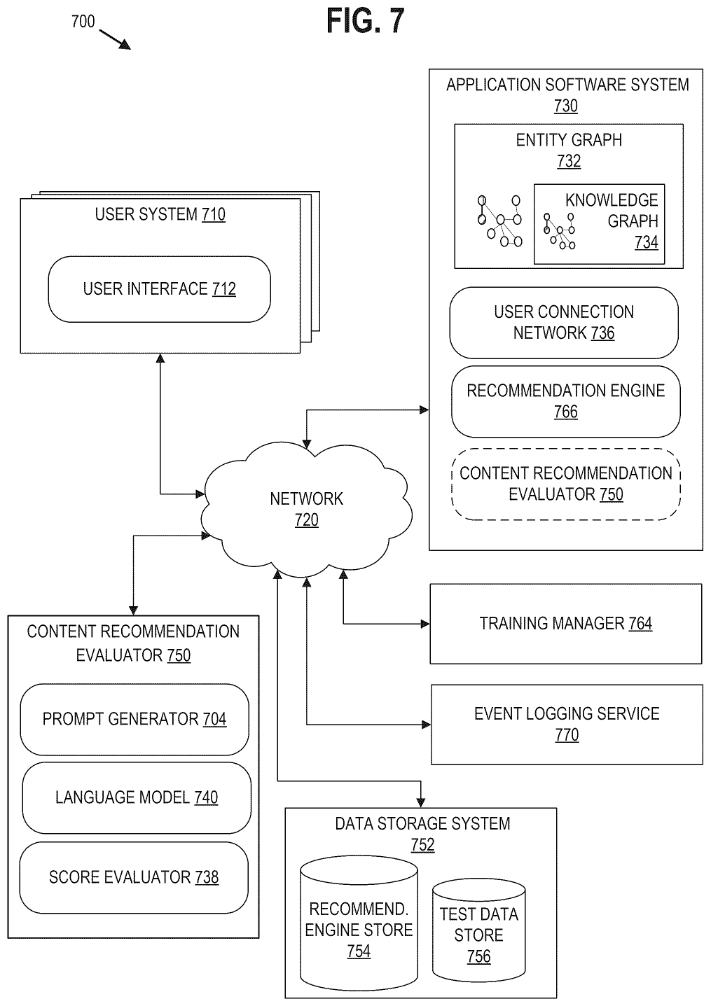

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a content recommendation evaluator 750 of FIG. 7, including, in some embodiments, components shown in FIG. 7 that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, computing system 100 includes a user system 110, a recommendation engine 122 and a content recommendation evaluator 136. The content recommendation evaluator 136 includes a prompt generator 104, language model 150, and a score evaluator 152. In the example of FIG. 1, the components of the content recommendation evaluator 136 are implemented using an application server or server cluster, which can include a secure environment (e.g., secure enclave, encryption system, etc.) for the processing of recommendations 128. In other implementations, one or more components of the content recommendation evaluator 136 are implemented on a client device. In yet other implementations, the components of the content recommendation evaluator 136 are executed as an application or service, executed remotely or locally.

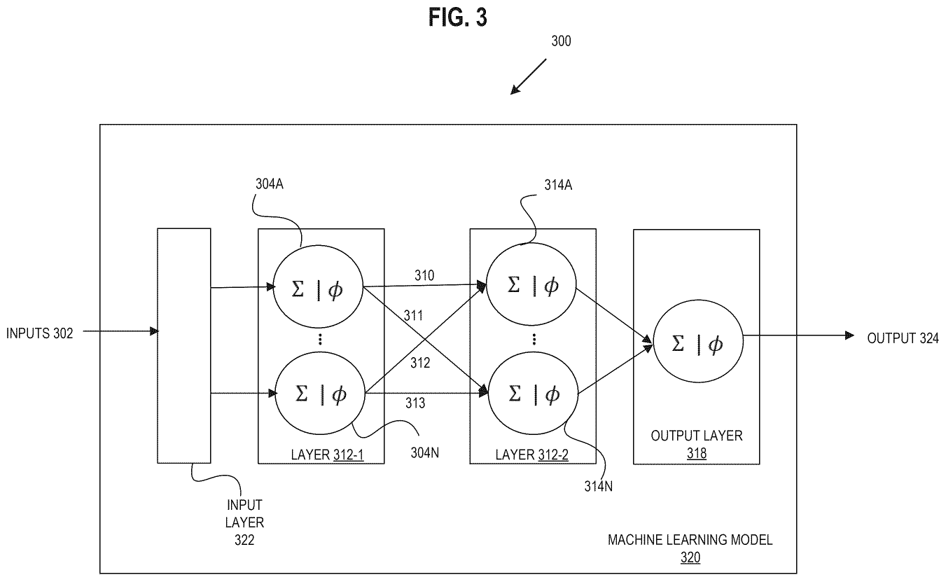

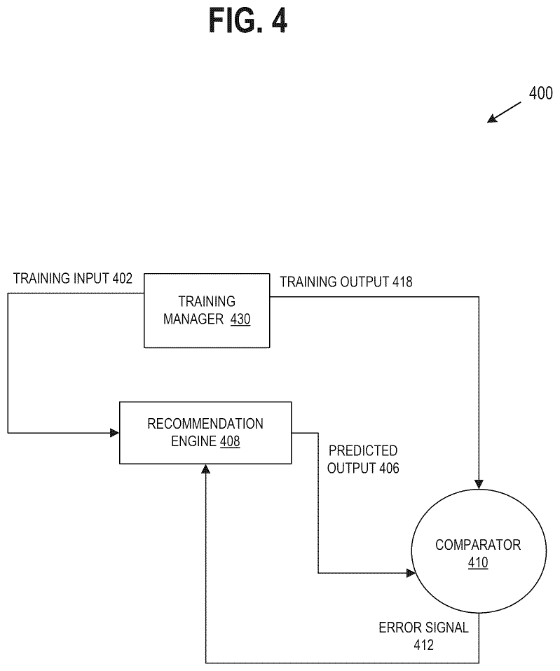

User system 110 includes at least one computing device, such as a personal computing device, a server, a mobile computing device, or a smart appliance. A user using user system 110 may be provided the monitoring result 154 determined from the content recommendation evaluator 136. The user can make one or more user configurations 108 to the recommendation engine 122 using the monitoring result 154. For example, user configurations 108 can include modifying the training data used to train the recommendation engine 122 based on the OTR score included in the monitoring result 154. Training the recommendation engine 122 using modified training data based on the OTR score is described in FIG. 4. Additionally or alternatively, user configurations 108 can include modifying one or more inputs and/or one or more outputs of the recommendation engine 122 to increase the quality of the recommendations 128. For example, a new input to the recommendation engine 122 can be based on the OTR score included in the monitoring result 154. Additionally or alternatively, the output of the recommendation engine 122 can be combined with the OTR score included in the monitoring result 154. Modifying one or more inputs or outputs of the recommendation engine 122 based on the OTR score is described in FIG. 3.

Test data 102 is the data used to monitor the performance of the recommendation engine 122 given a diverse set of test data 102 including at least test data 102A and test data 102B. In some embodiments, test data 102A and test data 102B (collectively referred to herein as test data 102) includes pairs of search queries 107 and corresponding user information 109 associated with the search query 107. User information 109 can include profile data 106A and/or entity connection data 106B. The user information 109 can be obtained from a variety of different data sources including user interfaces, databases and other types of data stores, including online, real-time, and/or offline data sources. In the example of FIG. 1, profile data 106a is received via one or more web servers and entity connection data 106b is received via one or more database servers.

In some embodiments when a user interacts with an application, the user may provide personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. Some or all of such information can be stored as profile data 106a. Profile data 106a may also include profile data of various organizations/entities (e.g., companies, schools, etc.), the user's search history and/or the user's previous activity within the same online session or across previous sessions. Profile data 106a can be obtained for the test data 102 by querying one or more data stores that store entity profile data for an application software system.

In some embodiments, when a user interacts with an application, the user engages with one or more other users of the application and/or content provided by the application. As a result, the entity graph 103, which represents entities, such as users, organizations (e.g., companies, schools, institutions), and content items (e.g., user profiles, job postings, announcements, articles, comments, and shares), updates nodes of the graph. Examples of entity connection data 106b include data extracted from entity graph 103 and/or knowledge graph 105.

One or more other components (not shown) traverse the entity graph 103 and/or knowledge graph 105 for entity connection data 106b associated with profile data 106a. As described herein, entity graph 103 represents relationships, also referred to as mappings or links, between or among entities as edges, or combinations of edges, between the nodes of the graph. In some implementations, mappings between or among different pieces of data are represented by one or more entity graphs (e.g., relationships between different users, between users and content items, or relationships between job postings, skills, and job titles). In some implementations, the edges, mappings, or links of the entity graph 103 indicate online interactions or activities relating to the entities connected by the edges, mappings, or links. For example, if a user views an article, an edge may be created connecting the user with the article in the entity graph, where the edge may be tagged with a label such as “viewed.”

Portions of entity graph 103 can be automatically re-generated or updated from time to time based on changes and updates to the stored data, e.g., in response to updates to entity data and/or activity data from a user. Also, entity graph 103 can refer to an entire system-wide entity graph or to only a portion of a system-wide graph, such as a sub-graph. For instance, entity graph 103 can refer to a sub-graph of a system-wide graph, where the sub-graph pertains to a particular entity or entity type.

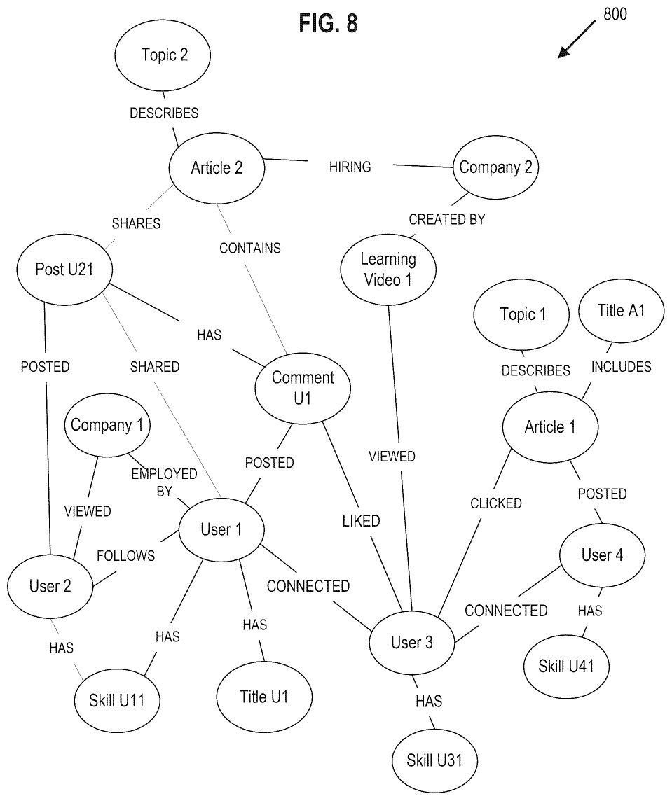

Not all implementations have a knowledge graph, but in some implementations, knowledge graph 105 is a subset of entity graph 103 or a superset of entity graph 103 that also contains nodes and edges arranged in a similar manner as entity graph 103 and provides similar functionality as entity graph 103. For example, in some implementations, knowledge graph 105 includes multiple different entity graphs 103 that are joined by cross-application or cross-domain edges or links. For instance, knowledge graph 105 can join entity graphs 103 that have been created across multiple different databases or across multiple different software products. As an example, knowledge graph 105 can include links between content items that are stored and managed by a first application software system and related content items that are stored and managed by a second application software system different from the first application software system. Additional or alternative examples of entity graphs and knowledge graphs are shown in FIG. 8, described below.

In some embodiments, the search query 107 is a historic search query performed by the user identified via user information 109. For example, the search query 107 is tagged with user information 109. In some embodiments, the user information 109 can include a user profile identifier (e.g., a number, a username, or an IP address), that links a user profile to a historic search query and also profile data 106a and/or entity connection data 106b associated with the user profile. In other embodiments, the search query 107 and user information 109 are determined by the user system 110. That is, a user using user system 110 manually determines a search query associated with a user profile including user information. In some embodiments, the user using user system 110 manually determines user information.

As shown, test data 102 can include different sets of test data 102 such as test data 102A and test data 102B. Test data 102A and test data 102B differ in terms of the content included in the particular set of test data. For example, in some embodiments, test data 102A includes data of a first type (e.g., dynamic search queries, where the content recommendation associated with a dynamic search query may change over time) and test data 102B includes data of a second type (e.g., static search queries, where the content recommendation associated with a static search query does not change over time).

In some embodiments, test data 102A and test data 102B differ in terms of the periodic updates. For example, test data 102A is updated with search queries 107 and corresponding user information 109 frequently (e.g., daily, weekly). For instance, test data 102A is updated with top search queries 107 for a particular day (e.g., the most requested search queries 107 over a range of user types such as users employed by a particular entity, unemployed users, female users, users within a certain age group, and the like). Applying the content recommendation evaluator 136 to test data 102A that is updated with a high frequency evaluates the recommendation engine 122 on data that represents dynamic user interest, user syntax, user style, etc. For example, over time users may change their search queries 107 from being searches of keywords or key phrases to acronyms. Additionally or alternatively, over time a user may change their search queries from searching for hiring information related to an entity (e.g., available hiring positions, employed individuals, etc.) to news related to the entity (e.g., latest product releases). That is, the content of the search query 107 changes over time for a particular user (or a group of users).

The dynamic nature of test data 102A (e.g., frequently updated with search queries and, in some embodiments, corresponding user information 109) ensures that test data 102A remains relevant and reflective of current search query trends. Accordingly, the test data 102A is used by the content recommendation evaluator 136 to capture the OTR scores of the recommendation engine 122 given current types of search queries such as search queries including different formats, vocabularies, content, and/or styles of search queries associated with user information 109.

In some embodiments, the test data 102B is updated with search queries 107 and corresponding user information at a frequency less than the frequency that test data 102A is updated. For example, test data 102B is updated every six months, whereas test data 102A is updated daily. Evaluating the recommendation engine 122 using test data 102B that is updated less frequently for instance, evaluates the recommendation engine 122 on a stable dataset. The test data 102B is used by the content recommendation evaluator 136 to capture the OTR scores of the recommendation engine 122 given a stable set of search queries 107 associated with user information.

In some embodiments, pairs of search queries 107 and corresponding user information 109 are randomly sampled from a set of stored search queries and corresponding user information to obtain test data 102. In other embodiments, test data 102 includes specific user information 109 and corresponding search queries 107. For example, test data 102 includes user information 109 of users who have recently accessed or otherwise updated their user profile during a predefined time period (e.g., the profile has been accessed in the last day, the last week, or the last month). In some embodiments, test data 102 includes search queries 107 that have been entered by users during a predetermined time period (e.g., the search query was entered in the last day, the last week, or the last month). In other embodiments, search queries 107 and/or user information 109 are determined by a user via user system 110. For example, a user can create a search query 107 that a user defined according to user information 109 may input as a search query.

In some embodiments, the recommendation engine 122 receives a search query 107 and the corresponding user information 109 from one or more test data sets (e.g., test data 102A or test data 102B). In some embodiments, only the search query 107 from a test data set is passed to the recommendation engine 122.

The recommendation engine 122 can include a software system designed to search for and retrieve information by executing queries on digital content items stored in any one or more databases. The recommendation engine 122 uses the search query 107 to find digital content items (e.g., recommendations 128) that match specified criteria, such as keywords and phrases of the search query 107. In some embodiments, the recommendation engine 122 retrieves digital content items (e.g., recommendations 128) from one or more external systems or databases. For example, the recommendation engine 122 can crawl digital content (e.g., websites) for digital content items associated with the search query 107. Alternatively or additionally, in some embodiments, the recommendation engine 122 retrieves data from other sources, such as profile data 106A, entity graph 103 and/or knowledge graph 105, and/or uses any of such other sources to identify and retrieve recommendations 128.

The recommendation engine 122 retrieves recommendations 128 (e.g., digital content items) that are associated with the search query 107 such as resumes, videos, articles, blogs, comments, entity profiles, and the like. The recommendation engine 122 can retrieve recommendations 128 using any suitable content retrieval methods. An example content retrieval method includes using embedding based retrieval to obtain digital content items (e.g., recommendations 128) that are semantically similar to the search query 107. Yet another example retrieval method includes using a graph database. For instance, the recommendation engine 122 can traverse one or more nodes of the graph database to obtain digital content items.

In some embodiments, the recommendation engine 122 uses an Application Programming Interface (API) to retrieve digital content items (e.g., recommendations 128). An API refers to an interface or communication protocol in a predefined format between a client and a server, for instance. In response to receiving an API call, an action is initiated and generally a response is communicated. For example, the recommendation engine 122 can request recommendations 128 using an API call to communicate the search query 107 and/or the user information 109 to one or more databases (not shown). Responsive to receiving the API call, the one or more external databases perform some processes to identify digital content items, if any, that are associated with the search query 107 and/or user information 109. The recommendation engine 122 receives the API response with digital content items (e.g., recommendations 128).

In some embodiments, the recommendation engine 122 ranks the recommendations 128. For example, the recommendation engine 122 can include a machine learning model trained to rank recommendations 128 according to a ranking score based on the search query 107 and/or the user information 109.

Listwise learning-to-rank algorithms are used by machine learning models to rank items in a list based on a permutation of items and not based on a score that each item receives. That is, with listwise learning-to-rank, the list of items retrieved in a search result is treated as a single unit. For example, given an input of a list of items A, B, C and the search query 107, an output of a model executing listwise ranking is a ranking of the list of items ABC, e.g., a ranking score that reflects the relevance of the entire list A, B, C to the search query 107. In contrast, pointwise learning-to-rank algorithms are used by machine learning models to rank items based on a score associated with each entry to be ranked. That is, with pointwise learning-to-rank, each item to be ranked is scored independently. For example, given the input of A, B, C and the search query 107, an output of a model executing pointwise ranking is a ranking score of each content recommendation. For example, content item A can receive a ranking score that represents content item A is 85% relevant to a search query 107, content item B can receive a ranking score that represents content item B is 50% relevant to the search query 107, and content item C can receive a ranking score that represents content item C is 20% relevant to the search query 107. In pairwise learning-to-rank, machine learning models rank pairs of neighboring entries according to a ranking score associated with the pairs of entries. For example, given the input of A, B, C and the search query 107, an output of a model executing pairwise ranking is a ranking score of pairs of inputs (e.g., content item A is 85% more relevant to the search query than content item B, content item B is 30% more relevant to the search query than content item C, etc.) Thus, whereas pointwise learning-to-rank computes a score for each individual item to be ranked (where the items are ranked based on the individual scores) and pairwise learning-to-rank computes a score for each pair of items to be ranked (where the pairs are ranked based on the scores computed for the pairs), listwise learning-to-rank computes a score for each list of items to be ranked (where the lists are ranked based on the scores computed for the lists).

In some embodiments, the content recommendation evaluator 136 is run multiple times for the same search query 107. For example, the recommendation engine 122 may determine different recommendations 128 for the same search query 107 and/or search query 107 and user information 109 pair. Additionally or alternatively, the recommendation engine 122 may determine different recommendations 128 for the same search query 107 and different users (e.g., unique user information 109). For instance, different users search the same query, which may result in different recommendations 128.

The prompt generator 104 generates a prompt, instructing the language model 150 to evaluate the recommendations 128 using an OTR score. The OTR score is a metric that represents the relevance of the retrieved digital content recommendations (e.g., recommendations 128) with respect to the search query 107 and in some embodiments, the user information 109. The OTR score may be a large value (representing a high-quality content recommendation, for instance) if the content recommendation describes one or more topics referred to in a search query and matches a user's search intent. A topic can be referred to in a search query if it is explicitly described in the search query and/or is semantically related to the search query. The OTR score may be a small value (representing a low-quality content recommendation) if the content recommendation does not refer a topic referred to in the search query, does not include a topic that is relevant to a user based on a user's search intent, or some combination. As described herein, the user's search intent can be simulated by the language model 150 using user information 109. In some embodiments, the user's search intent is not considered in evaluating the OTR score.

Unlike conventional methods that may use downstream metrics such as click (e.g., whether a user clicks on a content recommendation) or dwell (e.g., a duration of time that a user spends viewing a content recommendation) to determine a relevance of a content recommendation with respect to a search query, the language model 150 determines the OTR score to determine the relevance of recommendations 128 with respect to the search query 107.

Conventional approaches that evaluate the relevance of content recommendation using downstream metrics may be inaccurate as such methods depend on predicting whether the user will perform an action (e.g., clicking on a content recommendation). For example, such conventional methods can use downstream metrics to train a machine leaning model (such as a recommendation engine) to determine the likelihood that a content recommendation will result in a user interaction, instead of predicting whether the content is relevant to the search query and/or personalized to the user. Further, such metrics can be inaccurate at predicting the relevance of search query types during an online inference period where search queries received by the content recommendation engine are search queries of a different type from the search queries received during a training period and/or an offline inference period.

The language model 150 can determine the OTR score based on the similarity of content included in the search query and content included in the content recommendation. In some implementations, the language model 150 evaluates the similarity of content included in the search query and content included in the content recommendation using exact string matching, semantic similarity, or some combination. In some implementations, the similarity of content included in the search query and content included in the content recommendation is based on a threshold amount of similar content included in the search query and the content recommendation. For example, the language model 150 can determine a higher OTR score if a threshold number of semantically similar tokens are identified in both the digital content item and the search query. Additionally or alternatively, the language model 150 can determine a higher OTR score if a similarity metric (e.g., cosine similarity) of a number of embeddings in both the digital content item and the search query satisfies a threshold similarity score.

In some embodiments, the OTR score is further determined by the language model 150 based on a relevance of the content recommendation to a user. For example, using user information 109, the language model 150 can simulate the identity of a user associated with user information 109 and infer whether a content recommendation is relevant with respect to the simulated user identity. Incorporating user information 109 into the recommendation prompt 116 provides contextual information to the language model 150. For example, a digital content item (e.g., a profile) of a person named “Alex V.—a machine learning engineer” is more relevant to a job recruiter user, determined using user information 109, than is a digital content item (e.g., an article) of a product called “Alexa” given a search query “Alex.” In some implementations, a high OTR score represents a personalized content recommendation with respect to a user, and a low OTR score represents a generic content recommendation.

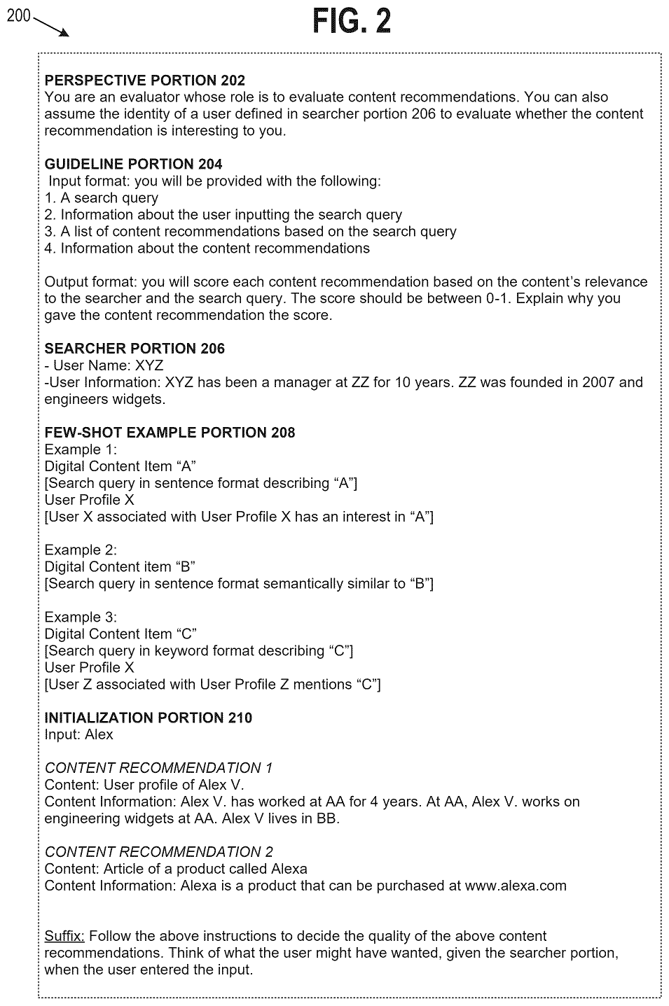

In operation, the prompt generator 104 generates the recommendation prompt 116 instructing the language model 150 to evaluate quality of the recommendations 128 by determining the OTR score. An example prompt is described in FIG. 2. In some embodiments, the recommendations 128 include an OTR score. For example, the recommendation engine 122 may determine an OTR score for each digital content recommendation with respect to the search query 107 and in some embodiments, the user information 109. The recommendation engine 122 may be trained to predict an OTR score, as described with reference to FIG. 4. In some embodiments, if the language model 150 is executed multiple times, the language model 150 determines the same OTR score given the same search query 107 and recommendations 128. In some embodiments, the language model 150 determines different OTR scores given the same search query 107, recommendations 128, and user information 109. That is, the OTR score represents the relevance of the content recommendation to a particular user, making the OTR score different depending on the user information 109.

The language model 150 can be any LLM. For example, the language model 150 can be a sequence-to-sequence machine learning model. In some embodiments, the language model 150 can include an instance of a text-based encoder-decoder model that accepts a string as an input (e.g., a search query included in recommendation prompt 116) and outputs a string (e.g., an OTR score with reasoning).

The language model 150 can assume the role of a relevance evaluator to determine the OTR score of the recommendations 128 included in the recommendation prompt 116. In some embodiments, each recommendation prompt 116 passed to the language model 150 is independent of other recommendation prompts 116. In some embodiments, the language model 150 can assume the role of a user defined according to user information included in the recommendation prompt 116. The language model 150 determines a recommendation evaluation 134 of the recommendation 128 using the search query 107 and in some embodiments, the user information 109 included in the recommendation prompt 116. As described herein, the language model 150 simulates a user search intent using the user information 109. In some embodiments, the language model 150 evaluates determines an OTR score for one or more recommendations included in recommendation 128 based on the recommendations being a relevant digital content item with respect to the search query 107 and/or a relevant digital content item with respect to the search query 107 and the user information 109.

In some embodiments, the language model 150 performs a binary classification of the content recommendations using the OTR score. For instance, the language model 150 can classify digital content recommendations of the recommendations 128 as being relevant (e.g., receive a value of ‘1’) or irrelevant (e.g., receive a value of ‘0’) based on the OTR score satisfying a quality threshold. The value of the OTR score represents a relevance of the content recommendation to the search query and in some embodiments, the user's search intent.

In some embodiments, the language model 150 ranks digital content recommendations using a scale based on the OTR score. For example, the OTR score can be compared to multiple quality thresholds to determine the relevance of content recommendations with respect to a scale. In some embodiments, the value ‘0’ represents an irrelevant content recommendation, the value ‘1’ represents a semi relevant content recommendation, and the value ‘2’ represents a relevant content recommendation.

In some embodiments, the language model 150 determines the OTR score for the top k number of digital content recommendations included in the recommendations 128. For example, the OTR score for the top k digital content recommendations can be determined according to Equation (1) below:

$${OTR}_{k} = \frac{{\sum }_{i = 1}^{k} OTR ( query , {content}_{positioni} )}{k} \qquad ( 1 )$$

As shown in Equation (1) above, the OTR score for the top k digital content recommendations is the average of the cumulative sum of OTR scores for each digital content recommendation. The value of the OTR score for each digital content recommendation can be a binary label (e.g., 0 or 1) or a value of a scale of values (e.g., value 0 to value 3), as described above.

In some embodiments, the OTR score for the top k digital content recommendations factors the ranking of the digital content recommendation. For example, the language model 150 can leverage the normalized discounted cumulative gain (NDCG), as shown in Equation (2) below:

$$\begin{matrix}Discounted Cumulative Gain ( DCG ) = {\sum }_{i = 1}^{k} \frac{OTR ( query , {content}_{positioni} )}{{log}_{2} ( i + 1 )} \\ Ideal Discounted Cumulative Gain ( IDCG ) = {\sum }_{i = 1}^{k} \frac{1}{{log}_{2} ( i + 1 )} \\ Normalized Discounted Cumulative Gain = \frac{DCG}{IDCG}\end{matrix} \qquad ( 2 )$$

The OTR normalized discounted cumulative gain is a binary value (e.g., value ‘0’ or value ‘1’) that represents whether the top k content recommendations are ranked according to relevance. The OTR DCG evaluates the top k content recommendations for each search query 107 by assigning a weight to each of the content recommendations based on the position in the top k ranking. As a result, the OTR DCG discounts the on-topic rate for digital content items that appear in later (e.g., lower ranked) positions.

In some embodiments, in addition to evaluating the OTR score of digital content recommendations of the recommendations 128, the language model 150 outputs a reason for the OTR score. For example, the reasoning can be a statement determined by the language model 150 such as “content recommendation 1 of recommendations 128 is not a high-quality content recommendation given the search query 107 and user information 109 because the content recommendation does not refer to a topic related to the search query 107.” Accordingly, the recommendation evaluation 134 includes one or more OTR scores (e.g., a measure of the relevance of a digital content item of the set of digital content items (e.g., recommendations 128) with respect to the search query 107 (and in some embodiments, the user information 109)) and a reason for the OTR scores.

The score evaluator 152 evaluates the quality of the recommendation engine 122 based on the recommendations 128. The quality of the recommendation engine 122 can be evaluated in terms of providing relevant on-topic digital content items, as represented by the OTR score from the recommendation evaluation 134. Additionally or alternatively, the quality of the recommendation engine 122 can be evaluated in terms of providing relevant ranked on-topic digital content items, as represented by the OTR score from the recommendation evaluation 134.

In some embodiments, the language model 150 evaluates the relevance of a single digital content item of recommendation 128 by determining an OTR score that represents the relevance of the digital content item with respect to a search query 107 and/or user information 109. In such embodiments, the score evaluator 152 determines the OTR score for k digital content recommendations included in recommendation 128 using Equation (1) or (2) above to evaluate the quality of the recommendation engine 122.

In some embodiments, the score evaluator 152 accumulates OTR scores such that the score evaluator 152 can evaluate the recommendation engine 122 based on the quality of the retrieved recommendations 128 for each search query 107 in a portion of test data 102 (e.g., test data 102A or test data 102B). For example, the score evaluator 152 scores the recommendation engine 122 once the score evaluator 152 has received OTR scores of 50% of the search queries 107 the test data 102A, for instance. In other embodiments, the score evaluator 152 scores the recommendation engine 122 once the score evaluator 152 has received all of the search queries 107 of the test data 102A, for instance.

In some embodiments, the score evaluator 152 algorithmically combines the OTR scores associated with the search queries from each set of test data 102. For example, the score evaluator 152 scores the recommendation engine 122 after algorithmically combining the OTR scores of the search queries 107 of the test data 102A with the OTR scores of the search queries 107 of the test data 102B to determine a total OTR score. The total OTR score represents the performance of the recommendation engine 122 based on a stable dataset (e.g., test data 102B) and a dynamic dataset (e.g., test data 102A).

In a non-limiting example, the score evaluator 152 determines the average of the OTR scores obtained from the test data 102A. The average of the OTR scores can be determined from one or more recommendation evaluations 134. For instance, a single recommendation evaluation 134 can include a single OTR score for a single digital content recommendation based on a single digital content recommendation of the recommendations 128. Additionally or alternatively, a single recommendation engine evaluation can include multiple OTR scores for multiple digital content recommendations (e.g., the recommendations 128). In some embodiments, the OTR scores encode ranking information if the position of the digital content recommendation of the set of digital content recommendations was determined (e.g., as described with respect to Equation (2) above, for instance). The score evaluator 152 can also take the average of the OTR scores determined from the test data 102B. In some embodiments, the score evaluator 152 combines the OTR scores associated with test data 102A and the OTR scores associated with test data 102A to determine the total OTR score of the recommendation engine 122. Other algorithmic combinations of OTR scores are also possible.

In some embodiments, the score evaluator 152 compares an OTR metric (e.g., the total OTR score, the OTR score of a dataset (such as test data 102A or test data 102B), an OTR score of the top k content recommendations, the OTR DCG, the OTR NDCG, or the like) to a quality threshold. If the OTR metric satisfies the quality threshold, then the score evaluator 152 determines that the recommendation engine 122 determined high-quality recommendations 128 (or a threshold number of recommendations 128 were high-quality). That is, the recommendation engine 122 was able to determine high-quality recommendations given a diverse set of test data 102, representing a low performance gap between the recommendations determined during a training period and recommendations during an inference period. Accordingly, the recommendations 128 were relevant with respect to the search query 107 and/or the user information 109, making the recommendations 128 personalized and relevant to a user search intent.

If the OTR score does not satisfy the quality threshold, then the score evaluator 152 determines that the recommendation engine 122 did not determine high-quality recommendations 128 (e.g., the recommendations 128 were low-quality, or a threshold number of recommendations were low-quality). That is, the recommendations 128 were not relevant with respect to the search query 107 and/or the user information 109. Accordingly, the recommendation engine 122 was not able to determine high-quality recommendations given a diverse set of test data 102, representing a large performance gap between recommendations determined during a training period and recommendations determined during an inference period (and in particular, the online inference period). As a result, there is an increased likelihood that the recommendation engine 122 should be modified to increase the quality of the recommendations 128. For example, the user may make one or more user configurations 108 to the training data of the recommendation engine 122. Such user modifications 108 are an example of the end-to-end approach for improving the recommendation engine 122 using the OTR score. In some embodiments, the modified training data can include the OTR score included in the monitoring result 154. Training the recommendation engine 122 using modified training data based on the OTR score included in the recommendation evaluation 134 is described in FIG. 4. Additionally or alternatively, a user can make one or more user configurations 108 to modify one or more inputs or one or more outputs of the recommendation engine 122 to increase the quality of the recommendations 128. Such user configurations 108 are an example of the end-to-end approach for improving the recommendation engine 122 using the OTR score. In some embodiments, a new input to the recommendation engine 122 can be based on the OTR score included in the monitoring result 154. Additionally or alternatively, a user can make one or more user configurations 108 to modify the output of the recommendation engine 122. Such user configurations 108 are an example of the end-to-end approach for improving the recommendation engine 122 using the OTR score. In some embodiments, the output of the recommendation engine 122 (e.g., a ranking score associated with a content recommendation) can be combined with the OTR score included in the monitoring result 154. Modifying one or more inputs or outputs of the recommendation engine 122 based on the OTR score included in the recommendation evaluation 134 is described in FIG. 3.

The result of the comparison of the OTR metric and the quality threshold is passed to the user system 110 via monitoring result 154. In some embodiments, the score evaluator 152 also passes the recommendation evaluation 134 such that a user of the user system 110 has access to the language model 150 reasoning associated with OTR scores determined for recommendations 128.

The examples shown in FIG. 1 and the accompanying description above are provided for illustration purposes. This disclosure is not limited to the described examples. Additional or alternative details and implementations are described herein.

FIG. 2 is an example of a prompt used to instruct a machine learning model to evaluate content recommendations, in accordance with some embodiments of the present disclosure.

As described herein, a language model uses a prompt to perform a task. The prompt 200 is an example of a prompt generated using prompt engineering to instruct a language model to evaluate the quality of one or more content recommendations.

The prompt 200 includes a perspective portion 202 that defines the perspective of the language model. For example, the perspective portion 202 states that the language model is an evaluator whose role is to evaluate content recommendations. Evaluating content recommendations includes determining the OTR score, which represents a relevance of the one or more digital content recommendations with respect to a search query and/or a user profile. The perspective portion 202 can also instruct the language model to simulate a user identity using the user information included in prompt 200. By simulating the user identity, the language model can determine the OTR score of the content recommendation with respect to the relevance of the content recommendation to a particular user (e.g., whether the content recommendation is personalized).

The guideline portion 204 provides more specific instructions to the language model. For example, an “input format” portion of the guideline portion 204 prepares the language model for the types of inputs it will receive. For example, the language model receives the search query as an input. The language model also receives information about the user that entered the search query obtained from the user profile information. The language model also receives one or more digital content items which are the content recommendations determined using a content recommendation engine (such as recommendation engine 122 described in FIG. 1). The digital content items included in the prompt 200 can include a reference to the digital content item (such as a URL, a document identifier such as a title, etc.) and/or content of the digital content item to be used by the language model (e.g., text or images of the digital content item).

The “output format” portion of the guideline portion 204 instructs the language model how to score each content recommendation included in the initialization portion 210. As described herein, the OTR score represents a relevance of the content recommendation to the search query and in some embodiments, the user searcher intent (based on the user profile information).

In some embodiments, the language model uses a binary classification to determine whether a content recommendation is a low-quality content recommendation or a high-quality content recommendation based on the OTR score. As an example, a low-quality content recommendation is a digital content item that is spammy, not safe for work, and/or does not make sense (e.g., irrelevant) relative to the search query. A high-quality content recommendation can be any content recommendation that is not a low-quality content recommendation. In other embodiments, the language model can rate each digital content item based on the OTR score. For example, the language model can use normalized discounted cumulative gain (NDCG) to rank the relevance of each content recommendation. Other scoring mechanisms can be used to rank the quality of content recommendations using the OTR score.

In yet other implementations, a rating scale is predefined and the language model rates each content recommendation using the rating scale. For example, a “2” represents a high-quality content recommendation which should be the first result of a set of content recommendations, a “1” represents a medium-quality suggestion such as a partially relevant and/or irrelevant content recommendation, and a “0” represents a low-quality content recommendation that should not have been recommended.

The searcher portion 206 includes information about the user inputting the search query. This information can be obtained (e.g., via prompt generator 104 of FIG. 1) using user profile information. As described herein, a user profile can be selected from a test data set. The input (shown in the initialization portion 210) is a previous search query associated with the selected user profile.

The prompt 200 includes few-shot example portion 208. Few-shot example portion 208 includes one or more examples of evaluating content recommendations. The digital content items included in the few-shot example portion 208 can include a reference to the digital content item (such as a URL, a document identifier such as a title, etc.) and/or content of the digital content item (e.g., text or images of the digital content item).

In some embodiments, the examples of the few-shot example portion 208 are manually determined. For instance, a user or other administrator selects one or more content recommendations that are relevant to a search query and/or a user profile. In operation, the user evaluates the quality of the content recommendation based on the user's intent when entering the search query. In some embodiments, the user assigns an OTR score to the content recommendations to represent the quality of the content recommendation.

The user-determined evaluation of a content recommendation (e.g., an OTR score) and the corresponding content recommendation, search query, and/or user profile is considered a manually determined input-output pair. The input of the manually determined input-output pair is what would be input to the language model, such as the content recommendation, the search query, and/or the user profile. The output of the manually determined input-output pair is what is expected as the output of the language model, such as the OTR score. In some embodiments, the user manually determines a reasoning for the OTR score, which is included in the few-shot example portion as a manually determined output of the input-output pair.

As shown in Example 1 of the few-shot example portion 208, digital content item “A” is a high-quality content recommendation given a search query in a sentence format that explicitly describes “A” and a user profile associated with a user that has an interest in “A.” As shown in Example 2, digital content item “B” is a high-quality content recommendation given a search query in a sentence format that includes semantically similar concepts to “B.” Example 2 is an example of a content recommendation evaluation that can be performed without a user profile such that the OTR score represents the relevance of the content recommendation with respect to the search query. As shown in Example 3, digital content item “C” is a high-quality content recommendation given a search query in a keyword format that describes concepts of “C” and a user profile that mentions “C.” While three examples are shown in the few-shot example portion 208, more examples or fewer examples can be included in the few-shot example portion 208. In some embodiments, the few-shot example portion 208 portion is not included in prompt 200.

The initialization portion 210 provides the digital content items to be evaluated and the search query to the language model. For example, the search query is the input “Alex.” As described herein, the search query can be in a sentence format (e.g., one or more natural language sentences), a keyword or key phrase format (e.g., one or more key words or key phrases), an acronym, or any other type of format of a search query. The initialization portion 210 also includes a suffix portion, which reinforces the information in the guideline portion 204. In some embodiments, the suffix portion is not included in a prompt 200.

As shown, prompt 200 is a batch prompt because it includes multiple content recommendations (e.g., content recommendation 1, and content recommendation 2) associated with a single user and a single search query (e.g., input “Alex”) in the initialization portion 210. In other words, a single prompt includes multiple content recommendations. Each content recommendation is evaluated using the single prompt such that the output of the language model is an evaluation of multiple content recommendations. In some embodiments, the prompt 200 is passed to a language model (such as language model 150 described in FIG. 1) using an API call. As described herein, an API refers to an interface or communication protocol in a predefined format between a client and a server, for instance. In response to receiving an API call, an action is initiated and generally a response is communicated. For example, the prompt generator 104 generating the batch prompt uses an API call to communicate the single batch prompt (including multiple content recommendations associated with a single user and a single search query) to the language model for evaluation. Responsive to receiving the API call with the batch prompt, the language model evaluates the quality of each content recommendation in the batch prompt and communicates an API response with evaluations for each content recommendation (e.g., an OTR score and/or reasoning for the OTR score) to the score evaluator 152 described in FIG. 1, for instance.

In other embodiments, the prompt includes a single content recommendation (e.g., content recommendation 1) associated with a single user and a single search query. In other words, a single prompt includes a single content recommendation, and the output of the language model is an evaluation of the single content recommendation.

FIG. 3 illustrates an example architecture of a machine learning model, in accordance with some embodiments of the present disclosure.

As described herein, a neural network is one example of a machine learning model. The example 300 illustrates a fully connected architecture of a machine learning model 320. As illustrated, the machine learning model 320 includes a stack of distinct layers (vertically oriented) that receive an input 302 between an input layer 322 and an output layer 318. The input layer 322 can perform some processing of the input 302 such as padding the input 302 and/or normalizing the input 302. The output layer 318 receives an input from each of the nodes of the adjacent layer 312-2 to determine an output 324.

A stack of layers allows the machine learning model 320 to perform sub-tasks associated with learning a particular task. For example, a stack of layers in the machine learning model 320 may perform an encoding sub-task, a pooling sub-task, a decoding sub-task, and an attention sub-task. The sub-tasks of the machine learning model 320 transform the input 302 into a latent space representation in which unobserved features are determined such that the relationship and other dependencies of such features can be learned. The stack of layers includes neurons (illustrated as nodes 304A-304N and 314A-314N) and weights (e.g., weights 310-313). The weights interconnecting the neurons can be visually represented as the weights 310-313.

In the machine learning model 320, the first layer 312-1 has nodes 304A-304N, and the second layer 312-2 has nodes 314A-314N. 320. The nodes 304A-304N and 314A-314N perform a particular computation and are interconnected to the nodes of adjacent layers. For example, node 304A in layer 312-1 is connected to nodes 314A-314N and node 304N in layer 312-1 is connected to nodes 314A-314N. For simplicity, other nodes and other connections are not shown. Each of the nodes 304A-304N and 314A-314N sum up the values from the adjacent nodes and apply an activation function, allowing the machine learning model 320 to detect nonlinear patterns in input 302.

Each of the nodes 304A-304N and 314A-314N are interconnected by weights 310-313. The weights 310-313 modify the effect of the connected nodes. For example, the node 304A applies an activation function to the input 302 to modify the input. The modified input is passed to the node 314A via weight 310. The value of the weight affects how the node 314A in layer 312-2 receives the output of node 304A in layer 31202. The values of the weights are tuned during training.

When supervised learning is used to train the machine learning model 320, the values of the weights are tuned based on an error (e.g., determined by comparing the output 324 to a known output). For example, the machine learning model 320 can be trained using backpropagation. The backpropagation algorithm operates by propagating the error through the machine learning model 320. The error may be calculated each training iteration (e.g., each input-output pair, as described with reference to FIG. 4), batch, and/or epoch and propagated through all of the weights in one or more stacks of layers in the machine learning model 320 such that the value of the weights adapt based on the amount of error. In some embodiments, the weights are updated by the steepest descent method. The steepest descent method is an optimization technique that minimizes a loss function. In other words, the steepest descent method is able to adjust unknown parameters (e.g., the value of each weight) in the direction of steepest descent. During training, the value of the weights that optimize the accuracy of the output 324 is unknown. Depending on the location of the neuron in the network, a different formula is used to determine how the weights are adjusted with respect to the loss function.

During each training iteration, the weights are tuned to reduce the amount of error thereby minimizing the differences between (or otherwise converging) a predicted output and an actual output. Training continues until the determined error is within a certain threshold (or a threshold number of batches, epochs, or iterations have been reached). Supervised learning is described in more detail with reference to FIG. 4.

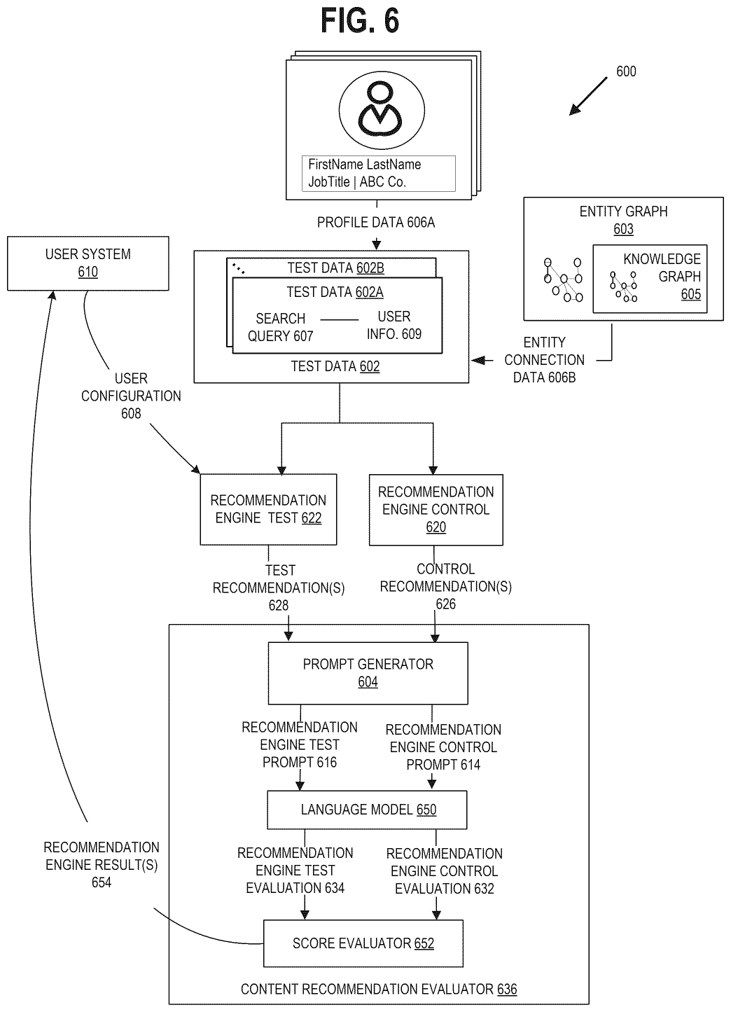

In some embodiments, the inputs 302 are based on the OTR score determined by the language model 150 described in FIG. 1 or the language model 650 described in FIG. 6. For example, in some embodiments, the OTR metric (e.g., the total OTR score, the OTR score of a dataset (such as test data 102A or test data 102B described in FIG. 1), the OTR score of the top k content recommendations, the OTR DCG, the OTR NDCG, or some other OTR metric determined using the score evaluator 152 described in FIG. 1 or the score evaluator 652 described in FIG. 6) is algorithmically combined with the inputs 302 of a machine learning model 320 (e.g., recommendation engine 122 described in FIG. 1, recommendation engine test 622 described in FIG. 6, or a recommendation engine deployed during an online inference period). For example, the OTR metric is added to the value of one or more inputs 302.

In some embodiments, one or more new input features that are correlated with the OTR metric are added as one or more new inputs 302 to the recommendation engine machine learning model (e.g., recommendation engine 122 described in FIG. 1, recommendation engine test 622 described in FIG. 6, or a recommendation engine deployed during an online inference period).

An example of a new input feature that is correlated with the OTR score is a similarity value determined using a search query embedding and a content recommendation embedding. Such a new input feature can be added as an input to inputs 302. An embedding is a latent space representation that encodes the meaning of a search query (e.g., a search query receiving during an inference period, or a search query included as test data such as test data 102 described in FIG. 1 or test data 602 described in FIG. 6) and a content recommendation in an embedding space. Embeddings of search queries and content recommendations that refer to similar or semantically similar topics are positioned closer together in embedding space.

To determine the similarity value with respect to the search query and the content recommendation, the embedding of the search query is compared to the embedding of the content recommendation. In some embodiments, cosine similarity is applied to the pairs of compared embeddings to quantify the similarity between the embeddings. In operation, the value of the cosine of the angle between the compared embeddings in embedding space indicates a similarity of embeddings. For example, higher, positive values (closer to 1) indicate greater degrees of similarity and lower, negative values (closer to 0) indicate greater degrees of dissimilarity.

In operation, the machine learning model (such as recommendation engine 122 described in FIG. 1, recommendation engine test 622 described in FIG. 6, or a recommendation engine deployed during an online inference period) receives a content recommendation and a search query. In some embodiments, one or more upstream processes (such as a second machine learning model for instance), determines the content recommendation embedding, the search query embedding, and the cosine similarity value between the content recommendation embedding and the search query embedding. Subsequently, machine learning model 320 receives the cosine similarity value between the content recommendation embedding and the search query embedding as an input 302.

In some embodiments, the reasoning determined by a language model (e.g., language model 150 described in FIG. 1 or language model 650 described in FIG. 6) can indicate a modification to inputs 302 and/or a new input to be added to inputs 302. In a non-limiting example, the reasoning determined by the language model can be a statement such as “content recommendation 1 of the provided list of content recommendations is not a high-quality content recommendation given the search query and user information because the content recommendation does not refer to a topic related to the search query.” After reviewing content recommendation 1 and the search query, it can be determined that the inputs 302 to the recommendation engine (e.g., machine learning model 320) should include information that better captures the content included in the content recommendation. Accordingly, a new input that better captures the content included in the content recommendation (such as an embedding of the content recommendation) can be added to inputs 302.

In some embodiments, the output 324 is modified based on the OTR score determined by the language model 150 described in FIG. 1 or the language model 650 described in FIG. 6. For example, in some embodiments, the OTR metric (e.g., the total OTR score, the OTR score of a dataset (such as test data 102A or test data 102B described in FIG. 1), the OTR score of the top k content recommendations, the OTR DCG, the OTR NDCG, or some other OTR metric determined using the score evaluator 152 described in FIG. 1 or the score evaluator 652 described in FIG. 6) is algorithmically combined with the output 324 of a machine learning model 320 (e.g., recommendation engine 122 described in FIG. 1, recommendation engine test 622 described in FIG. 6, or a recommendation engine deployed during an online inference period). For example, the output 324 can be a matrix of values representing a ranking score of each content item recommendation. In some embodiments, the OTR score is added to the ranking score in output 324. In some embodiments, if the sum of the OTR score and the ranking score satisfies a quality threshold, then the content item recommendation associated with the summed OTR score and ranking score can be determined to be a high-quality content recommendation and presented for display to a user. In some embodiments, the top k combinations of OTR scores and ranking scores that satisfy the quality threshold are presented for display to a user.

FIG. 4 is a flow diagram of an example method for training a recommendation engine using supervised learning, in accordance with some embodiments of the present disclosure.

Supervised learning is a method of training a machine learning model given input-output pairs. An input-output pair (e.g., training input 402 and corresponding training output 418) is an input with an associated output (e.g., an expected output, a labeled output, a ground truth). For example, a training input 402 can include a search query, and a training output 418 can include one or more content recommendations and corresponding OTR scores. In some embodiments, the training input 402 can include a search query and one or more content recommendations, and the training output 418 includes the corresponding OTR scores.

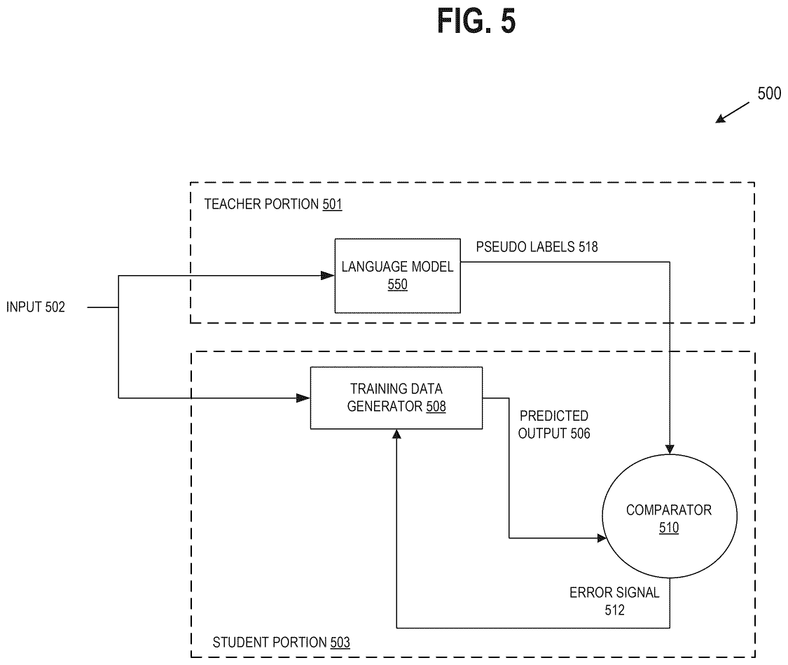

In some embodiments, an OTR score associated with a content recommendation (included as part of the training output 418) can be determined by the language model 150 described in FIG. 1 or the language model 650 described in FIG. 6. In some embodiments, the OTR score associated with the content recommendation (included as part of the training output 418) can be determined by the training data generator 508 described in FIG. 5. In yet other embodiments, the OTR score associated with the content recommendation (included as part of the training output 418) can be determined manually (e.g., via a user or administrator such as a user using user system 110 described in FIG. 1).

Recommendation engine 408 can be a machine learning model such as recommendation engine 122 described in FIG. 1 or recommendation engine test 622 described in FIG. 6. The training manager 430 trains the recommendation engine 408 to retrieve one or more digital content items associated with a search query and score the digital content recommendation using an OTR score. In some embodiments, the recommendation engine 408 ranks the digital content items as a set of content recommendations using a learning to rank algorithm as described above. In some embodiments, the retrieval of the one or more digital content items and/or the ranking of the content recommendations is further based on user profile information. That is, the user profile information can be included as part of training input 402 to the recommendation engine 408.

In example 400, the training manager 430 provides the training input 402 to the recommendation engine 408. The recommendation engine 408 predicts output 406 by applying nodes in one or more layers of the recommendation engine 408 to the training input 402. The nodes of the recommendation engine 408 are adjusted based on an error determined by comparing the training output 418 to the predicted output 406. The adjustment of the weights during training facilitates the recommendation engine's 408 ability to develop statistical correlations used to score a relevance of a digital content recommendation to a search query (e.g., an OTR score). In some embodiments, the adjustment of the weights during training facilitates the recommendation engine's 408 ability to develop statistical correlations used to determine an OTR score (e.g., a relevance) of a digital content recommendation associated with a search query and a user search intent (simulated using user profile information provided in training input 402). In operation, the recommendation engine 408 iteratively develops statistical correlations that enable the recommendation engine to infer complex relationships between the user profile information, the search query, the content recommendation, and the OTR score.

In some embodiments, the comparator 410 compares the predicted output 406 (e.g., a predicted OTR score associated with a content recommendation and a corresponding search query and/or user profile information) to the training output 418 (e.g., a labeled OTR score associated with the content recommendation and the corresponding search query and/or user search intent) to determine an amount of error or difference between the predicted output 406 and the training output 418.

In some embodiments, the predicted output 406 and the training output 418 is an ordered list of digital content items (e.g., a ranking) based on the OTR score. As described herein, there are multiple learning-to-rank algorithms, including pointwise, pairwise, and listwise. Each of the learning-to-rank algorithms returns an output in a different format. For example, when the recommendation engine 408 is trained to rank according to the pointwise method, the training output 418 and predicted output 406 include a content recommendation with a corresponding OTR score. When the recommendation engine 408 is trained to rank according to the pairwise method, the training output 418 and predicted output 406 include pairs of content recommendations with their corresponding OTR scores (e.g., each content recommendation is associated with an OTR score) indicating which entry in the pair of entries is more relevant to the search query and/or user search intent. When the recommendation engine 408 is trained to rank according to the listwise method, the training output 418 and predicted output 406 include a set of ranked lists, where each ranked list in the set of ranked lists has a corresponding OTR score.

The error signal 412 is used to adjust the weights in the recommendation engine 408 such that the recommendation engine 408 iteratively converges, e.g., changes (or learns) over time. The weighting coefficients of the recommendation engine 408 may be tuned to reduce the amount of error thereby minimizing the differences between (or otherwise converging) the predicted output 406 and the training output 418. The recommendation engine 408 may be trained by the training manager 430 until the error determined at the comparator 410 is within a certain threshold (or a threshold number of batches, epochs, or iterations have been reached).

The recommendation engine 408 may be trained using a backpropagation algorithm, for instance. The backpropagation algorithm operates by propagating the error signal 412 through each of the algorithmic weights of the recommendation engine 408 such that the algorithmic weights adapt based on the amount of error. The error signal 412 may be calculated at each iteration (e.g., each pair of training inputs 402 and associated training outputs 418), batch, and/or epoch. The error is computed using a loss function. Non-limiting examples of loss functions may include the square error function, the room mean square error function, and/or the cross-entropy error function.

As a result of supervised learning, the recommendation engine 408 is trained to determine an OTR score for digital content recommendation and in some embodiments, rank digital content recommendations The value of the weights is stored such that the trained recommendation engine 408 can be deployed during inference time and/or compared to a baseline recommendation engine (such as recommendation engine control 620 described in FIG. 6).

FIG. 5 is a flow diagram of generating OTR scores for use as training data using a student-teach framework, in accordance with some embodiments of the present disclosure.

The teacher-student framework, illustrated by teacher portion 501 and student portion S03, is an example of a semi-supervised training method. In the teacher-student framework, the student portion 503 is trained to generate data based on the output of the teacher portion 501. In other words, the language model 550 of the teacher portion 501 is being deployed during an offline inference period to train the training data generator 508 of the student portion 503 during a training period. After the training period, the training data generator 508 is trained to determine an OTR score for a digital content recommendation (or one or more OTR scores for one or more digital content recommendations) and/or rank the digital content recommendations based on the OTR score. The digital content recommendation and OTR score determined by the training data generator 508 can be used as an input-output pair to train the recommendation engine 408 described in FIG. 4, where the input of the input-output pair can include the digital content recommendation, search query, and user profile information and the output of the input-output pair can include the OTR score corresponding to the digital content recommendation.

In some embodiments, the language model 550 of the teacher portion 501 is trained using supervised learning, described with reference to FIG. 4. The language model 550 can be trained to determine an OTR score associated with a content recommendation. In operation, the language model 550 receives training inputs including one or more digital content recommendations, a corresponding search query, and in some instances, user profile information (such that the language model 550 can determine a user search intent). As described with reference to FIG. 4, the language model determines a predicted output which is compared to the training output. The training output can include a manually determined OTR score (e.g., determined via a user using user system 110 described in FIG. 1 for instance) for one or more digital content recommendations. In some embodiments, the training output is an ordered list of one or more digital content recommendations with a corresponding OTR score.

After the training period, the language model 550 iteratively develops statistical correlations that enable the language model 550 to determine an OTR score for one or more search queries using a digital content item, and/or user profile information. In some embodiments, the language model 550 can generate a reasoning for the OTR score.

In other embodiments, the language model 550 of the teacher portion 501 is pretrained. For example, the language model 550 can be a generative pretrained transformers (GPT). The language model 550 of the teacher portion 501 can be similar to language model 150 described in FIG. 1 and/or the language model 650 described in FIG. 6.

The training data generator 508 of the student portion 503 is trained to generate training data using pseudo labels 518 generated from the teacher model language model 550 of the teacher portion 501. In some embodiments, the training data generator 508 is similar to the language model 550 (e.g., a LLM), but the training data generator 508 can have a smaller architecture than that of the language model 550. For example, the training data generator 508 can have fewer layers, weights, nodes than the layers, weights and/or nodes of the language model 550, making the training data generator 508 more computationally efficient than the language model 550.

In operation, inputs 502 are fed to both the training data generator 508 of the student portion 503 and the language model 550 of the teacher portion 501. The inputs 502 can be a prompt (such as prompt 200 described in FIG. 2) including one or more digital content recommendations and a corresponding search query and/or user profile information. As described herein, the language model 550 of the teacher portion 501 has been previously trained to determine an OTR score for the digital content recommendations and/or rank the digital content recommendations. Accordingly, the pseudo label 518 output of the language model 550 is the determination of the OTR score for the digital content recommendations and/or the ranked digital content recommendations. In some embodiments, the pseudo label 518 includes a reasoning of the OTR score for the digital content recommendations and/or the ranked digital content recommendations.

The pseudo label 518 becomes the training output (e.g., training output 418 described in FIG. 4) used to train the training data generator 508 to determine an OTR score of one or more digital content recommendations and/or rank one or more digital content recommendations. The generated input-output pairs (e.g., the input 502 and pseudo label 518) reduce the need for manually labeled input-output pairs by supplementing any available manually labeled input-output pairs, thereby conserving computing resources associated with manually labeling input-output pairs and time spent manually labeling input-output pairs.

The training data generator 508 of the student portion 503 predicts output 506 by applying nodes in one or more layers of the training data generator 508 to the input 502. The nodes of the training data generator 508 are adjusted based on an error determined by comparing the pseudo label 518 to the predicted output 506. The adjustment of the weights during the training period facilitates the training data generator's 508 ability to determine an OTR score associated with a digital content recommendation and corresponding search query and/or user profile information.

The comparator 510 compares the predicted output 506 to the pseudo labels 518 to determine an amount of error or difference between the predicted output 506 and the pseudo labels 518. When the predicted output 506 and the pseudo labels 518 include an OTR score and/or a ranking of digital content items, the comparator 510 can compute the error between the OTR score in the predicted output 506 and the OTR score in the pseudo label 518 using the square error function, the root mean square error function, and/or the cross-entropy error function, for instance. When the predicted output 509 and the pseudo labels 518 include a reasoning for the OTR score, the comparator 510 can compute the error using any natural language processing evaluation metric. For example, the comparator 510 can evaluate the reasoning by calculating a recall-oriented understudy for Gisting Evaluation (ROUGE) score.

Determining the error signal 512 using the ROUGE score involves calculating, by the comparator 510, a recall score and a precision score. The recall score is an indication of how much of the reasoning included in the pseudo labels 518 is in the reasoning included in the predicted output 506. For example, the recall score can be a ratio of the overlapping number of tokens between the reasoning in the pseudo labels 518 and the reasoning in the predicted output 506, to the total number of tokens of the reasoning in the pseudo labels 518. The precision score is an indication of the relevance of the reasoning in the predicted output 506 with respect to the reasoning in the pseudo labels 518. For example, the precision score can be a ratio of the overlapping number of tokens between the reasoning in the predicted output 506 and the reasoning in the pseudo labels 518 to the total number of tokens in the reasoning of the predicted output 506. The precision score and/or recall score can be passed to the training data generator 508 as part of error signal 512.

The error signal 512 is used to adjust the weights in the training data generator 508 such that after a set of training iterations, the training data generator 508 iteratively converges, e.g., changes (or learns) over time to generate an acceptably accurate (predicted output 506 using the pseudo labels 518 determined from the teacher portion 501. The training data generator 508 generates an acceptably accurate predicted output 506 when the error between the predicted output 506 and the pseudo labels 518 satisfies a defined tolerance or confidence level, for instance.

The training data generator 508 of the student portion 503 receives the benefit of developing statistical correlations that are similar to those language model 550 of the teacher portion 501 by virtue of training the predicted output 506 using the pseudo labels 518, even though the training data generator 508 is more efficient than the language model 550 (e.g., the training data generator 508 has fewer nodes than the language model 550, fewer weights than the language model 550, fewer layers than the language model 550, a different architecture from the language model 550, is not pretrained like the language model 550).

FIG. 6 is a flow diagram of an example method for evaluating multiple content recommendations, in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of a content recommendation evaluator 750 of FIG. 7, including, in some embodiments, components shown in FIG. 7 that may not be specifically shown in FIG. 6. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 6, computing system 600 includes a user system 610, a recommendation engine test 622, a recommendation engine control 620, and a content recommendation evaluator 636. The content recommendation evaluator 636 includes a prompt generator 604, language model 650, and a score evaluator 652. In the example of FIG. 6, the components of the content recommendation evaluator 636 are implemented using an application server or server cluster, which can include a secure environment (e.g., secure enclave, encryption system, etc.) for the processing of test recommendations 628 and control recommendations 626. In other implementations, one or more components of the content recommendation evaluator 636 are implemented on a client device. In yet other implementations, the components of the content recommendation evaluator 636 are executed as an application or service, executed remotely or locally.

User system 610 includes at least one computing device, such as a personal computing device, a server, a mobile computing device, or a smart appliance. A user using user system 610 may configure one or more aspects of the recommendation engine test 622 via user configurations 608.

In some embodiments, user configurations 608 can include modifying the training data used to train the recommendation engine test 622. As described herein, the modified training data can be based on the OTR score included in the monitoring result 154 described in FIG. 1. Additionally or alternatively, the modified training data can be based on the OTR score included in the recommendation engine results 654. Training the recommendation engine test 622 using modified training data based on the OTR score is described in FIG. 4.

Additionally or alternatively, user configurations 608 can include modifying one or more inputs and/or one or more outputs of the recommendation engine test 622 to increase the quality of the test recommendations 628. For example, a new input to the recommendation engine test 622 can be based on the OTR score included in the monitoring result 154 described in FIG. 1 and/or the recommendation engine results 654. Additionally or alternatively, the output of the recommendation engine 122 can be combined with the OTR score included in the monitoring result 154 described in FIG. 1 and/or the recommendation engine results 654. Modifying one or more inputs and/or outputs of the recommendation engine test 622 based on the OTR score is described in FIG. 3.

In some embodiments, user configurations 608 can be used to change the training data (e.g., train the recommendation engine test 622 to determine an OTR score for each content recommendation, as described in FIG. 4) and keep the inputs and/or outputs to the recommendation engine test 622 the same. That is, the recommendation engine test 622 can be trained using a new set of input-output pairs as training data. In some embodiments, user configurations 608 can include new inputs/modified outputs to the recommendation engine test 622 and keep the training data the same. That is, the recommendation engine test 622 can be retrained using the same set of training data that the recommendation engine test 622 was previously trained on and new inputs based on the OTR score and/or modified outputs based on the OTR score. In some embodiments, user configurations 608 can include some combination of modified training data, modified inputs, and modified outputs based on the OTR score.

In some embodiments, user configurations 608 can include a modification to one or more parameters of the recommendation engine test 622 based on the OTR score (e.g., one or more hyperparameters such as the number of layers in a neural network model, the number of neurons in one or more layers of the neural network model, the loss function used to train the neural network model, one or more bias terms, one or more momentum terms, or one or more inputs passed to the neural network model). In some implementations, the user configurations 608 make recommendation engine test 622 a different recommendation model from the recommendation engine control 620, and/or the user configurations 608 make the recommendation engine test 622 trained differently (using different training data, or using a different objective function, for instance) from the recommendation engine control 620. In some embodiments, the user configurations 608 are based on the recommendation engine result(s) 654 determined from the content recommendation evaluator 636. As a result of one or more user configurations 608, one or more control recommendations 626 determined from the recommendation engine control 620 are different from the one or more test recommendations 628 determined from the recommendation engine test 622.

The content recommendation evaluator 636 compares the test recommendations 628 determined from the recommendation engine test 622 to the control recommendations 626 determined from the recommendation engine control 620. The recommendation engine test evaluation 634 is compared against the recommendation engine control evaluation 632 to determine which recommendation engine (e.g., recommendation engine test 622 or recommendation engine control 620 associated with recommendation engine test evaluation 634 and recommendation engine control evaluation 632 respectively) provided more high-quality content recommendations based on the test recommendations 628 or control recommendations 626. In some embodiments, the content recommendation evaluator 636 compares one or more OTR scores of the recommendation engine test 622 to one or more OTR scores of the recommendation engine control 620. Accordingly, a user can determine whether the configurations 608 improved the performance of the recommendation engine test 622 or not (e.g., the recommendation engine control 620 outperformed the recommendation engine test 622 with respect to recommending more high-quality content recommendations, by virtue of the higher OTR scores associated with content recommendations and/or ranked content recommendations determined via recommendation engine control evaluation 632 than the OTR scores associated with content recommendation and/or ranked content recommendations determined via recommendation engine test evaluation 634).

Test data 602 can be similar to test data 102 described in FIG. 1. Test data 602 is the data used to evaluate the recommendation engine test 622 and the recommendation engine control 620. For example, test data 602A and test data 602B (collectively referred to herein as test data 602) includes pairs of search queries 607 and corresponding user information 609 associated with the search query 607. In some embodiments, test data 602A and test data 602B differ in terms of the content included in the particular set of test data (e.g., static search queries, dynamic search queries, search queries in a first format, search queries in a second format). In some embodiments, test data 602A and test data 602B differ in terms of periodic updates.

As described with reference to FIG. 1, user information 609 can include profile data 606A and/or entity connection data 606B. Examples of profile data 606a include user experience, interests, areas of expertise, educational history, job titles, skills, job history, user search history and/or the user's previous activity within the same online session or across previous sessions. Examples of entity connection data 606b include data extracted from entity graph 603 and/or knowledge graph 605. In some embodiments, the search query 607 can a historic search query performed by the user identified via user information 609. In other embodiments, the search query 607 and user information 609 are determined by the user system 610.

As described with reference to FIG. 1, the dynamic nature of a test data set (e.g., test data 602A for instance), in terms of the type of search queries included in the test data set (e.g., dynamic search queries) and/or in terms of the frequency of updates to the test data set (e.g., high frequency updates) ensures that test data set remains relevant and reflective of current search query trends. Accordingly, the test data set (e.g., test data 602A) is used by the content recommendation evaluator 636 to capture the OTR score of the recommendation engine test 622 and the recommendation engine control 620 given current types of search queries such as search queries including different formats, vocabularies, content, and/or styles of search queries 607 associated with user information 609.

The static nature of a different test data set (e.g., test data 602B for instance), in terms of the type of search queries included in the test data set (e.g., static search queries) and/or in terms of the frequency of updates to the test data set (e.g., low frequency updates) ensures that the test data is stable. Accordingly, the test data set (e.g., test data 602B) can serve as a safeguard against user configurations 608 made to the recommendation engine test 622 that regress the performance of the recommendation engine test 622. That is, using the stable test data set (e.g., test data 602B), the content recommendation evaluator 636 can ensure that the recommendation engine test 622 can identify high-quality content recommendations and low-quality content recommendations and rank the content recommendations accordingly. Accordingly, the content recommendation evaluator 636 can determine whether the user configurations 608 made to the recommendation engine test 622 result in regression or instead maintain parity or improve the recommendation evaluation 134 of the recommendation engine test 622. In some embodiments, the content recommendation evaluator 636 can compare a previous performance of the recommendation engine test 622 (e.g., test recommendations 628 determined at a previous time period and/or the OTR scores determined at a previous time period) to the current performance of the recommendation engine test 622 (e.g., test recommendations 628 determined using the recommendation engine test 622, OTR scores determined using the recommendation engine test 622). Accordingly, a different test data set (e.g., test data 602B) is used by the content recommendation evaluator 636 to capture the OTR scores of the recommendation engine test 622 and the recommendation engine control 620 given a stable set of search queries 607 associated with user information.

The recommendation engine test 622 and/or the recommendation engine control 620 can include a software system designed to search for and retrieve information by executing queries on digital content items stored in any one or more databases. The recommendation engine test 622 and/or the recommendation engine control 620 use the search query 607 to find digital content items (e.g., test recommendations 628 and control recommendations 626 respectively) that match specified criteria, such as keywords and phrases of the search query 607. In some embodiments, the recommendation engine test 622 and/or the recommendation engine control 620 can retrieve digital content items (e.g., test recommendations 628 and control recommendations 626 respectively) from one or more external systems or databases. For example, the recommendation engine test 622 and/or the recommendation engine control 620 can crawl digital content (e.g., websites) for digital content items associated with the search query 607. Alternatively or additionally, in some embodiments, the recommendation engine test 622 and/or the recommendation engine control 620 retrieve data from other sources, such as profile data 606A, entity graph 603 and/or knowledge graph 605, and/or uses any of such other sources to identify and retrieve test recommendations 628 and control recommendations 626 respectively.

In some embodiments, the recommendation engine test 622 and recommendation engine control 620 retrieve the test recommendations 628 and control recommendations 626 using the same retrieval technique (e.g., querying the same data stores). In other embodiments, the recommendation engine test 622 and recommendation engine control 620 retrieve the test recommendations 628 and control recommendations 626 using different retrieval techniques (e.g., querying different datastores, using different retrieval techniques). Different example retrieval techniques include embedding based retrieval methods and/or using a graph database, as described with reference to FIG. 1. In some embodiments, the recommendation engine test 622 and/or the recommendation engine control 620 use an Application Programming Interface (API) to retrieve digital content items (e.g., test recommendations 628 and control recommendations 626 respectively).

The recommendation engine test 622 and the recommendation engine control 620 receive the search query 607 and user information 609 from one or more test data sets (e.g., test data 602A or test data 602B) and determine test recommendations 628 and control recommendations 626 respectively. In some embodiments, only the search query 607 from a test data set is passed to the recommendation engines (e.g., the recommendation engine control 620 and the recommendation engine test 622). The test recommendations 628 and control recommendations 626 are digital content items that are associated with the search query such as resumes, videos, articles, blogs, comments, entity profiles, and the like.

In some embodiments, the recommendation engine test 622 and/or the recommendation engine control 620 rank the test recommendations 628 and the control recommendations 626 respectively. For example, the recommendation engine test 622 can include a first machine learning model trained to rank test recommendations 628 according to a relevance of the search query 607 and/or a relevance of the search query given the user information 609. Similarly, the recommendation engine control 620 can include a second machine learning model trained to rank control recommendations 626 according to a relevance of the search query and/or a relevance of the search query given the user information 609.

In some embodiments, the first machine learning model of the recommendation engine test 622 is different from the second machine learning model of the recommendation engine control 620. For example, the first machine learning model of the recommendation engine test 622 is different from the second machine learning model of the recommendation engine control 620 based on one or more of user configurations 608, training data, architecture, ranking algorithm, input features, and the like. In some embodiments, the first machine learning model of the recommendation engine test 622 is the same as the second machine learning model of the recommendation engine control 620. In these embodiments, a difference between the recommendation engine test 622 and the recommendation engine control 620 is the databases used to retrieve digital content items (e.g., test recommendations 628 and control recommendations 626 respectively).

Similar to the prompt generator 104 described in FIG. 1, the prompt generator 604 generates a prompt, instructing the language model 650 to evaluate the test recommendations 628 and the control recommendations 626 using an OTR score, which is a metric that measures the relevance of the retrieved digital content recommendations (e.g., test recommendations 628 and control recommendations 626 respectively) with respect to the search query 607 and/or user information 609.

In operation, the prompt generator 604 generates the recommendation engine control prompt 614 instructing the language model 650 to evaluate the control suggestions 626 using one or more OTR scores. The prompt generator 604 also generates recommendation engine test prompt 616 instructing the language model 650 to evaluate the test recommendations 628 using one or more OTR scores. In some embodiments, a single recommendation engine control prompt 614 evaluates the one or more control recommendations 626 and a single recommendation engine test prompt 616 evaluates the one or more test recommendations 628. In other embodiments, the prompt generator 604 generates multiple prompts (e.g., multiple recommendation engine control prompts 614 and multiple recommendation engine test prompts 616), each prompt instructing the language model 650 to evaluate a single recommendation of the set of test recommendations 628 and control recommendations 626 respectively with respect to the search query 607 and/or user information 609.

The recommendation engine test prompt 616 is different from the recommendation engine control prompt 614 by virtue of the ranked and/or retrieved digital content items (e.g., test recommendations 628 and control recommendations 626 respectively). For example, the recommendation engine test prompt 616 includes one or more test recommendations 628. Similarly, the recommendation engine control prompt 614 includes one or more control recommendations 626.

In some embodiments, the retrieved digital content items and/or ranking of the digital content items (e.g., test recommendations 628 and/or control recommendations 626 respectively) are based, in part, on the user intent when inputting the search query 607. To simulate a user intent, the prompt generator 604 includes user information 609 in each prompt. Incorporating user information 609 into the recommendation engine test prompt 616 and the recommendation engine control prompt 614 provides contextual information to the language model 650.

While the digital content item suggestions and/or rank of the digital content item suggestions of each prompt vary, the instructions of the recommendation engine test prompt 616 and the recommendation engine control prompt 614 can be the same. Accordingly, a recommendation engine test prompt 616 with a first evaluation instruction evaluates a test recommendation 628 using a search query 607 and, in some embodiments, a corresponding user information 609. Similarly, a recommendation engine control prompt 614 with the first evaluation instruction evaluates a control recommendation 626 using the search query 607 and the corresponding user information 609. In this manner, the OTR of the digital content recommendations is evaluated given the same evaluation instructions, the same search query, and the same user profile.

Similar to the language model 150 described in FIG. 1, the language model 650 can be a LLM. The prompt generator 604 instructs the language model 650 to assume the role of a relevance evaluator to determine the OTR score of the digital content suggestion(s) included in both the recommendation engine test prompt 616 and the recommendation engine control prompt 614. While the language model 650 is illustrated as receiving both the recommendation engine test prompt 616 and the recommendation engine control prompt 614 in parallel, in some embodiments, the language model 650 receives the recommendation engine test prompt 616 and the recommendation engine control prompt 614 in series such that the language model 650 evaluates the OTR score of the digital content recommendations of a first prompt and subsequently evaluates the OTR of the digital content recommendations of a second prompt.

The language model 650 determines a recommendation engine test evaluation 634 for the test recommendations 628 and a recommendation engine control evaluation 632 for the control recommendations 626. The language model 650 evaluates the test recommendations 628 and the control recommendations 626 using search query 607 and in some embodiments, the user information 609 included in the recommendation engine test prompt 616 and the recommendation engine control prompt 614 respectively. In some embodiments, the language model 650 simulates a user search intent using the user information 609.

In some embodiments, the language model 650 evaluates each digital content item in test recommendations 628 and control recommendations 626 respectively as being a relevant digital content item with respect to the search query 607 and/or a relevant digital content item with respect to the search query 607 and the user information 609 using an OTR score. In some embodiments, in addition to evaluating the digital content recommendation of the test recommendations 628 and control recommendations 626 respectively, the language model 650 outputs a reason for the OTR score. Accordingly, the recommendation engine test evaluation 634 can include one or more OTR scores (e.g., a measure of the relevance of a digital content item of the set of digital content items (e.g., test recommendations 628) with respect to the search query 607 (and in some embodiments, the user information 609)) and a reason for the OTR score. Similarly, the recommendation engine control evaluation 632 can include one or more OTR scores (e.g., a measure of the relevance of a digital content item of the set of digital content items (e.g., control recommendations 626) with respect to the search query 607 (and in some embodiments, the user information 609)) and a reason for the OTR score.

In some embodiments, the score evaluator 652 compares the recommendation engine test evaluation 634 and the recommendation engine control evaluation 632 to determine whether the recommendation engine test 622 outperformed the recommendation engine control 620 (e.g., in terms of providing more high-quality or relevant on-topic digital content items, as determined using the OTR score and/or in terms of providing more high-quality or relevant ranked on-topic digital content items, as determined using the OTR score).

The score evaluator 652 can be similar to the score evaluator 152 described in FIG. 1. For example, in some embodiments, the score evaluator 652 determines the OTR for k digital content recommendations in test recommendations 628 and control recommendations 626 using Equation (1) or (2) above to evaluate the quality of recommendation engine test 622 and recommendation engine control 620 respectively. In some embodiments, the score evaluator 652 accumulates OTR scores such that the score evaluator 652 can evaluate the recommendation engine test 622 and the recommendation engine control 620 based on the quality of the retrieved digital content recommendations for each search query 607 in a portion of test data 602 (e.g., test data 602A or test data 602B). For example, the score evaluator 652 scores the recommendation engine test 622 and the recommendation engine control 620 once the score evaluator 652 has received OTR scores of 50% of the search queries 607 the test data 602A, for instance. In other embodiments, the score evaluator 652 scores the recommendation engine test 622 and the recommendation engine control 620 once the score evaluator 652 has received all of the search queries 607 of the test data 602A, for instance.

In some embodiments, the score evaluator 652 algorithmically combines the OTR scores associated with the search queries from each set of test data 602. For example, the score evaluator 652 scores the recommendation engine test 622 and the recommendation engine control 620 after algorithmically combining the OTR scores of the search queries 607 of the test data 602A with the OTR scores of the search queries 607 of the test data 602B to determine a total OTR score. The total OTR score represents the performance of the recommendation engine (e.g., recommendation engine test 622 and the recommendation engine control 620) based on a stable dataset (e.g., test data 602B) and a dynamic dataset (e.g., test data 602A). Determining the total OTR score for a recommendation is described in FIG. 1.

In some embodiments, the score evaluator 652 compares an OTR metric (e.g., the total OTR score, the OTR score of a dataset (such as test data 602A or test data 602B), an OTR score of the top k content recommendations, the OTR DCG, the OTR NDCG, or the like) of the recommendation engine test 622 and the OTR metric (e.g., the total OTR score, the OTR score of a dataset (such as test data 602A or test data 602B), an OTR score of the top k content recommendations, the OTR DCG, the OTR NDCG, or the like) of the recommendation engine control 620 to determine a recommendation engine result 654. The recommendation engine associated with the higher OTR metric, for instance, is determined to be the recommendation engine that provides more high-quality digital content recommendations. In some embodiments, the recommendation engine result 654 includes one or more OTR metrics of both the recommendation engine test 622 and the recommendation engine control 620. In some embodiments, the recommendation engine result 654 includes the reasoning included in the recommendation engine test evaluation 634 and the reasoning included in the recommendation engine control evaluation 632.

The score evaluator 652 passes the recommendation engine result 654 to the user system 610 such that the user system can make user configurations 108 to the recommendation engine test 622 and/or save the results of the recommendation engine result 654. In some embodiments, the score evaluator 652 also passes the recommendation engine test evaluation 634 and recommendation engine control evaluation 632 such that a user at the user system 610 has access to the language model 650 reasoning associated with the OTR scores determined for test recommendations 628 and control recommendations 626.

The examples shown in FIG. 6 and the accompanying description above are provided for illustration purposes. This disclosure is not limited to the described examples. Additional or alternative details and implementations are described herein.

FIG. 7 is a block diagram of a computing system that includes a content recommendation evaluator and a training manager, in accordance with some embodiments of the present disclosure.

In the embodiment of FIG. 7, a computing system 700 includes one or more user systems 710, a network 720, an application software system 730, a content recommendation evaluator 750, a data storage system 752, and an event logging service 770. Dashed lines are used in FIG. 7 to indicate that all or portions of the content recommendation evaluator 750 can be implemented directly by the application software system 730. Accordingly, all or at least some components of the content recommendation evaluator 750 are implemented at application software system 730. For example, the content recommendation evaluator 750 can be implemented directly upon a single device without the need to communicate with, e.g., one or more servers over the Internet.

A user system 710 includes at least one computing device, such as a personal computing device, a server, a mobile computing device, or a smart appliance, and at least one software application that the at least one computing device is capable of executing, such as an operating system or a front end of an online system. In some embodiments, a user of user system 710 can be an administrator (such as the user using user system 110 described in FIG. 1 or the user using user system 610 described in FIG. 6). In other embodiments, a user of user system 710 can be a registered user associated with the application software system 730.

Many different user systems 710 can be connected to network 720 at the same time or at different times. Different user systems 710 can contain similar components as described in connection with the illustrated user system 710. For example, many different end users of computing system 700 can be interacting with many different instances of application software system 730 through their respective user systems 710, at the same time or at different times.

User system 710 includes a user interface 712. User interface 712 is installed on or accessible to user system 710 by network 720. The user interface 712 can include, for example, a graphical display screen that includes graphical user interface elements such as at least one input box or other input mechanism and at least one slot. A slot as used herein refers to a space on a graphical display such as a web page or mobile device screen, into which digital content such as message suggestions and messages can be loaded for display to the user. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system.

User interface 712 can be used to input data such as a search query and receive content such as digital content items and/or content recommendation engine evaluation results (e.g., such as the monitoring result 154 described in FIG. 1 or the recommendation engine results 654 described in FIG. 6). In some embodiments, the user interface 712 can be used to generate training data (e.g., manually determine an OTR score associated with a previous digital content recommendation and a corresponding previous search query input by a user associated with a user profile). In some embodiments, the user interface 712 can be used to make one or more modifications to recommendation engine 766 based on the content recommendation engine evaluation results (e.g., such as the monitoring result 154 described in FIG. 1 or the recommendation engine results 654 described in FIG. 6).

In some implementations, user interface 712 enables the user to upload, download, receive, send, or share of other types of digital content items, including posts, articles, comments, and shares, to initiate user interface events, and to view or otherwise perceive output such as data and/or digital content retrieved using application software system 730. For example, user interface 712 can include a graphical user interface (GUI), a conversational voice/speech interface, a virtual reality, augmented reality, or mixed reality interface, and/or a haptic interface. User interface 712 includes a mechanism for logging in to application software system 730, clicking or tapping on GUI user input control elements, interacting with content recommendations, and displaying digital content items. Examples of user interface 712 include web browsers, command line interfaces, and mobile app front ends. User interface 712 as used herein can include application programming interfaces (APIs).

Network 720 includes an electronic communications network. Network 720 can be implemented on any medium or mechanism that provides for the exchange of digital data, signals, and/or instructions between the various components of computing system 700. Examples of network 720 include, without limitation, a Local Area Network (LAN), a Wide Area Network (WAN), an Ethernet network or the Internet, or at least one terrestrial, satellite or wireless link, or a combination of any number of different networks and/or communication links.

Application software system 730 includes any type of application software system that provides or enables the creation, upload, display, and/or distribution of at least one form of content recommendation including digital content such as user profiles, articles, comments, and videos between or among user systems, through user interface 712. In some implementations, portions of the content recommendation evaluator 750 are components of application software system 730. Components of application software system 730 can include an entity graph 732 and/or knowledge graph 734, a user connection network 736, and a recommendation engine 766.

In the example of FIG. 7, application software system 730 includes an entity graph 732 and/or a knowledge graph 734. Entity graph 732 and/or knowledge graph 734 include data organized according to graph-based data structures that can be traversed via queries and/or indexes to determine relationships between entities. An example of an entity graph is shown in FIG. 8, described herein. For example, as described in more detail with reference to FIG. 8, entity graph 732 and/or knowledge graph 734 can be used to compute various types of affinity scores, similarity measurements, and/or statistics between, among, or relating to entities. Such information can be included in a prompt as part of the user profile information and passed to the language model 740. As described herein, the language model 740 can use such user profile information to predict a user search intent such that the relevance of the digital content recommendation is personalized and can be determined based on the predicted user search intent.

As described herein, entity graph 732, 734 includes a graph-based representation of data stored in data storage system 752, described herein. For example, entity graph 732, 734 represents entities, such as users, organizations, and content items, such as posts, articles, comments, and shares, as nodes of a graph. Entity graph 732, 734 represents relationships, also referred to as mappings or links, between or among entities as edges, or combinations of edges, between the nodes of the graph. In some implementations, mappings between different pieces of data used by application software system 730 are represented by one or more entity graphs. In some implementations, the edges, mappings, or links indicate online interactions or activities relating to the entities connected by the edges, mappings, or links.

In some implementations, knowledge graph 734 is a subset or a superset of entity graph 732. For example, in some implementations, knowledge graph 734 includes multiple different entity graphs 732 that are joined by edges. For instance, knowledge graph 734 can join entity graphs 732 that have been created across multiple different databases or across different software products. In some implementations, knowledge graph 734 includes a platform that extracts and stores different concepts that can be used to establish links between data across multiple different software applications. Examples of concepts include topics, industries, and skills.

Knowledge graph 734 includes a graph-based representation of data stored in data storage system 752, described herein. Knowledge graph 734 represents relationships, also referred to as links or mappings, between entities or concepts as edges, or combinations of edges, between the nodes of the graph. In some implementations, mappings between different pieces of data used by application software system 730 or across multiple different application software systems are represented by the knowledge graph 734.

User connection network 736 includes, for instance, a social network service, professional social network software and/or other social graph-based applications. Application software system 730 can include online systems that provide social network services, general-purpose search engines, specific-purpose search engines, messaging systems, content distribution platforms, e-commerce software, enterprise software, or any combination of any of the foregoing or other types of software. For example, one or more search engines of the user connection network 736 calls the recommendation engine 766 to rank or score the relevance of one or more digital content recommendations using an OTR score.

A front-end portion of application software system 730 can operate in user system 710, for example as a plugin or widget in a graphical user interface of a web application, mobile software application, or as a web browser executing user interface 712. In an embodiment, a mobile app or a web browser of a user system 710 can transmit a network communication such as an HTTP (HyperText Transfer Protocol) request over network 720 in response to user input that is received through a user interface provided by the web application, mobile app, or web browser, such as user interface 712. A request is formulated, e.g., by a browser or mobile app at a user device, in connection with a user interface event such as a login, click on a graphical user interface element, or a page load. The request includes, for example, a network message such as an HTTP request for a transfer of data from an application front end to the application's back end, or from the application's back end to the front end, or, more generally, a request for a transfer of data between two different devices or systems, such as data transfers between servers and user systems.

In the example of FIG. 7, the application software system 730 includes a recommendation engine 766. The recommendation engine 766 can include a software system designed to search for and retrieve information by executing queries for digital content items stored in any one or more databases. The recommendation engine 766 can use a received search query to find digital content items that match specified criteria, such as keywords and phrases of the search query. In some embodiments, the recommendation engine 766 retrieves digital content items from one or more external systems or databases. For example, the recommendation engine 766 can crawl digital content (e.g., websites) for digital content items associated with the search query.

The recommendation engine 766 can retrieve digital content items using any suitable content retrieval methods. An example content retrieval method includes using embedding based retrieval to obtain digital content items that are semantically similar to the search query. Yet another example retrieval method includes using a graph database. For instance, the recommendation engine 766 can traverse one or more nodes of the graph database (e.g., entity graph 732 and/or knowledge graph 734) to obtain digital content items. In some embodiments, the recommendation engine 766 uses an API to retrieve digital content items.

In some embodiments, the recommendation engine 766 ranks the retrieved digital content recommendations. For example, the recommendation engine 766 can include a machine learning model trained to rank the digital content recommendations according to a relevance of the search query and/or a relevance of the search query given user information. In some embodiments, the recommendation engine 766 is trained to determine an OTR score associated with each digital content recommendation according to a relevance of the search query and/or a relevance of the search query given user information

The content recommendation evaluator 750 is used to evaluate the quality of one or more digital content recommendations using an OTR score. In the example of FIG. 7, the content recommendation evaluator 750 includes a prompt generator 704, a language model 740, and a score evaluator 738.

The prompt generator 704 creates a prompt including information such as one or more digital content recommendations, user information (such as profile data 102A and entity connection data 106B described in FIG. 1), and guideline information (such as guideline portion 204 described in FIG. 2). The prompt instructs the language model 740 to evaluate the quality of one or more content recommendations with respect to a search query and in some embodiments, with respect to user information. Accordingly, the language model 740 evaluates one or more content recommendations by determining an OTR score. A high-quality content recommendation can receive a high OTR score and a low-quality content recommendation can receive a low OTR score.

The language model 740 evaluates the quality of the one or more content recommendations using the prompt. The quality of the content recommendation can be represented using an OTR score. In some embodiments, the language model 740 determines the OTR scores of content recommendations with respect to the relevance of the content recommendation and the search query and/or the user profile. In some embodiments, the language model 740 performs a binary classification of the content recommendations using the OTR score. In some embodiments, the language model 740 uses the OTR score to rank content recommendations. In some embodiments, the language model 740 determines an OTR score for the top k content recommendations in a set of recommendations. In yet other embodiments, the language model 740 generates a reasoning for the OTR score.

As described with reference to score evaluator 152 described in FIG. 1, the score evaluator 738 can evaluate the recommendation engine 766 based on one or more OTR scores associated with content recommendations determined by the recommendation engine 766. As described with reference to the score evaluator 652 described in FIG. 6, the score evaluator 738 can compare multiple content recommendation evaluations to determine which, of multiple content recommendation engines, determined more high-quality content recommendations.

The training manager 764 can train one or more machine learning models. In some embodiments, the training manager 764 is included as part of the content recommendation evaluator 750 and/or the application software system 730.

The training manager 764 can be used to modify the recommendation engine 766 using modified input data (e.g., a new feature selected as a new input to the recommendation engine based on monitoring result 154 described in FIG. 1 and/or recommendation engine result(s) 654 described in FIG. 6). The training manager 764 can also be used to modify the recommendation engine 766 by adding the OTR score (e.g., determined using monitoring result 154 described in FIG. 1 and/or recommendation engine result(s) 654 described in FIG. 6) to a ranking score at the output of the recommendation engine 766. Additionally or alternatively, the training manager 764 can train a recommendation engine using new training data (such as training data manually determined by one or more users and/or training data generated using pseudo labels). Training the recommendation engine is described with reference to FIG. 4.

In some embodiments, the training manager 764 can train a training data generator (such as the training data generator 508 described with reference to FIG. 5). For example, as described with reference to FIG. 5, the training manager 764 can train the language model (e.g., language model 550) of the teacher portion (e.g., teacher portion 501) in the student-teacher framework using manually determined training data; the training manager 764 can provide inputs (e.g., a search query, one or more digital content recommendations, and in some instances user profile information in the form of a prompt) to the student portion (e.g., the training data generator 508 of the student portion 503) and the teacher portion (e.g., the language model 550 of the teacher portion 501) of the student-teacher framework; and the training manager 764 can compare the predicted output of the training data generator of the student portion (e.g., predicted output 506 determined by training data generator 508) and the pseudo labels output by the language model of the teacher portion (e.g., pseudo labels 518 determined by the language model 550) using a comparator (e.g., comparator 510). As described herein, the training data generator is used to generate the pseudo labels that are used to train the recommendation engine to determine an OTR score associated with a search query (and in some instances, user profile information) and one or more content recommendations such that the quality of the content recommendation can be determined (e.g., high-quality content recommendations can be associated with high OTR scores and low-quality content recommendations can be associated with low OTR scores).

Event logging service 770 captures and records network activity data generated during operation of application software system 730, including user interface events generated at user systems 710 via user interface 712, in real time, and formulates the user interface events into a data stream that can be consumed by, for example, a stream processing system. Examples of network activity data include clicks on digital content recommendations suggestions, executed searches, and social action data such as likes, shares, comments. For instance, when a user of application software system 730 via a user system 710 clicks on a user interface element, such as a digital content recommendation, or a user interface control element such as a view, comment, share, or uploads a file, or creates a message, loads a web page, or scrolls through a feed, etc., event logging service 770 fires an event to capture an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile. In this manner, the data storage system 752 can store search queries, digital content recommendations, and an associated user profile in the test data store 756.

Data storage system 752 includes data stores and/or data services that store digital data received, used, manipulated, and produced by application software system 730, content recommendation evaluator 750, and training manager 764 including a recommendation engine store 754 and test data store 756.

The recommendation engine store 754 stores one or more benchmark recommendation engines (e.g., other versions of recommendation engine 766). The benchmark recommendation engines are compared to new (or modified, experimental) recommendation engines to determine whether the new recommendation engine is an improvement over the benchmark recommendation engine, as described in FIG. 6. For example, as described with reference to FIG. 4 and FIG. 3, modifications can be made to recommendation engine 766 (in terms of providing the recommendation engine 766 a new input, modifying the output of the recommendation engine 766, and/or training the recommendation engine 766 using new training data based on the OTR score). In response to the new recommendation engine outperforming a benchmark recommendation engine (e.g., based on the new recommendation engine suggesting more high-quality content recommendations than the stored recommendation engine), the new recommendation engine can become stored in the recommendation engine store 754 as a benchmark recommendation engine such that additional improvements can be made to future recommendation engines. In some embodiments, the recommendation engine store 754 stores previous content recommendations and corresponding search queries.

The test data store 756 stores test data. Test data can include a search query and corresponding user information (e.g., profile data 106A and entity connection data 106B described in FIG. 1 or profile data 606A and entity connection data 606B described in FIG. 6). The test data stored in the test data store 756 can include multiple sets of test data such as test data 102A and test data 102B described in FIG. 1.

In some embodiments, the data storage system 752 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of the data storage system 752 can be configured to store data produced in real-time and/or offline (e.g., batch) data processing. A data store configured for real-time data processing can be referred to as a real-time data store. A data store configured for offline or batch data processing can be referred to as an offline data store. Data stores can be implemented using databases, such as key:value stores, relational databases, and/or graph databases. Data can be written to and read from data stores using query technologies, e.g., SQL or NoSQL.

A key:value database, or key:value store, is a nonrelational database that organizes and stores data records as key:value pairs. The key uniquely identifies the data record, i.e., the value associated with the key. The value associated with a given key can be, e.g., a single data value, a list of data values, or another key:value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

The data storage system 752 resides on at least one persistent and/or volatile storage device that can reside within the same local network as at least one other device of computing system 700 and/or in a network that is remote relative to at least one other device of computing system 700. Thus, although depicted as being included in computing system 700, portions of data storage system 752 can be part of computing system 700 or accessed by computing system 700 over a network, such as network 720.

While not specifically shown, it should be understood that any of user system 710, application software system 730, content recommendation evaluator 750, data storage system 752, training manager 764, and event logging service 770 includes an interface embodied as computer programming code stored in computer memory that when executed causes a computing device to enable bidirectional communication with any other of user system 710, application software system 730, content recommendation evaluator 750, data storage system 752, training manager 764, or event logging service 770 using a communicative coupling mechanism. Examples of communicative coupling mechanisms include network interfaces, inter-process communication (IPC) interfaces and application program interfaces (APIs).

Each of user system 710, application software system 730, content recommendation evaluator 750, data storage system 752, training manager 764, and event logging service 770 is implemented using at least one computing device that is communicatively coupled to electronic communications network 720. Any of user system 710, application software system 730, content recommendation evaluator 750, data storage system 752, training manager 764, and event logging service 770 can be bidirectionally communicatively coupled by network 720. User system 710 as well as other different user systems (not shown) can be bidirectionally communicatively coupled to application software system 730, training manager 764, and/or content recommendation evaluator 750.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 710, application software system 730, content recommendation evaluator 750, data storage system 752, training manager 764, and event logging service 770 are implemented using computer software, hardware, or software and hardware, and can include combinations of automated functionality, data structures, and digital data, which are represented schematically in the figures. User system 710, application software system 730, content recommendation evaluator 750, data storage system 752, training manager 764, and event logging service 770 are shown as separate elements in FIG. 7 for ease of discussion but, except as otherwise described, the illustration is not meant to imply that separation of these elements is required. The illustrated systems, services, and data stores (or their functionality) of each of user system 710, application software system 730, content recommendation evaluator 750, data storage system 752, training manager 764, and event logging service 770 can be divided over any number of physical systems, including a single physical computer system, and can communicate with each other in any appropriate manner.

FIG. 8 is an example of an entity graph, in accordance with some embodiments of the present disclosure.

The entity graph 800 can be used by an application software system, e.g., to support a user connection network, in accordance with some embodiments of the present disclosure. The entity graph 800 can be used (e.g., queried or traversed) to obtain user information, which is associated with search query 107 of FIG. 1 or search query 607 of FIG. 6. The user information can include profile data 106A and/or entity connection data 106B described in FIG. 1. The user information is included as part of a prompt and passed to a language model (e.g., language model 150 described in FIG. 1, and/or language model 650 described in FIG. 6) such that the language model can simulate a user intent. The user intent is used to evaluate the quality of content recommendations associated with a search query such that a high-quality content recommendation is personalized with respect to the user intent. For example, content recommendation may be high-quality given a first user intent, whereas the content recommendation may be low-quality given a second user intent. In some embodiments, the user intent and the entity graph 800 can be used to generate content recommendation based on search queries.

The user information can also be passed to the recommendation engine (e.g., recommendation engine 122 described in FIG. 1, recommendation engine test 622 and recommendation engine control 620 described in FIG. 6) such that the recommendation engine can use the statistical correlations developed during a training period to infer complex relationships between the search query, user information, digital content recommendation, and/or OTR score.

An entity graph includes nodes, edges, and data (such as labels, weights, or scores) associated with nodes and/or edges. Nodes can be weighted based on, for example, edge counts or other types of computations, and edges can be weighted based on, for example, affinities, relationships, activities, similarities, or commonalities between the nodes connected by the edges, such as common attribute values (e.g., two users have the same job title or employer, or two users are n-degree connections in a user connection network).

A graphing mechanism is used to create, update and maintain the entity graph. In some implementations, the graphing mechanism is a component of the database architecture used to implement the entity graph 800. For instance, the graphing mechanism can be a component of data storage system 752 and/or application software system 730, shown in FIG. 7, and the entity graphs created by the graphing mechanism can be stored in one or more data stores of data storage system 752.

The entity graph 800 is dynamic (e.g., continuously updated) in that it is updated in response to occurrences of interactions between entities in an online system (e.g., a user connection network) and/or computations of new relationships between or among nodes of the graph. These updates are accomplished by real-time data ingestion and storage technologies, or by offline data extraction, computation, and storage technologies, or a combination of real-time and offline technologies. For example, the entity graph 800 is updated in response to user updates of user profiles, user connections with other users, and user creations of new content items, such as messages, posts, articles, comments, and shares.

In some embodiments, the entity graph 800 includes a knowledge graph that contains cross-application links. For example, message activity data obtained from a messaging system can be linked with entities of the entity graph.

In the example of FIG. 8, entity graph 800 includes entity nodes, which represent entities, such as content item nodes (e.g., Post U21, Article 1, Learning Video 1), and user nodes (e.g., User 1, User 2, User 3, User 4. Entity graph 800 also includes attribute nodes, which represent attributes (e.g., job title data, article title data, skill data, topic data) of entities. Examples of attribute nodes include title nodes (e.g., Title U1, Title A1), company nodes (e.g., Company 1), topic nodes (Topic 1, Topic 2), and skill nodes (e.g., Skill A1, Skill U11, Skill U31, Skill U41).

Entity graph 800 also includes edges. The edges individually and/or collectively represent various different types of relationships between or among the nodes. Data can be linked with both nodes and edges. For example, when stored in a data store, each node is assigned a unique node identifier and each edge is assigned a unique edge identifier. The edge identifier can be, for example, a combination of the node identifiers of the nodes connected by the edge and a timestamp that indicates the date and time at which the edge was created. For instance, in the graph 800, edges between user nodes can represent online social connections between the users represented by the nodes, such as ‘friend’ or ‘follower’ connections between the connected nodes. As an example, in the entity graph 800, User 3 is a first-degree connection of User 1 by virtue of the CONNECTED edge between the User 3 node and the User 1 node, while User 2 is a second-degree connection of User 3, although User 1 has a different type of connection, FOLLOWS, with User 2 than with User 3.

In the entity graph 800, edges can represent activities involving the entities represented by the nodes connected by the edges. For example, a POSTED edge between the User 2 node and the Post U21 node indicates that the user represented by the User 2 node posted the digital content item represented by the Post U21 node to the application software system (e.g., as educational content posted to a user connection network). As another example, a SHARED edge between the User 1 node and the Post U21 node indicates that the user represented by the User 1 node shared the content item represented by the Post U21 node. Similarly, the CLICKED edge between the User 3 node and the Article 1 node indicates that the user represented by the User 3 node clicked on the article represented by the Article 1 node, and the LIKED edge between the User 3 node and the Comment U1 node indicates that the user represented by the User 3 node liked the content item represented by the Comment U1 node.

As described herein, profile data 106A and/or entity connection data 106B described in FIG. 1 can be obtained using the entity graph 800 by traversing the nodes and edges of the entity graph 800. For example, given a user identifier associated with a particular user node (e.g., User 1), information about the user can be obtained by traversing the edges of the User 1 node. For example, the user represented by the User 1 node is employed at Company 1; the user represented by the User 1 node is connected to the user represented by User 3 node and follows the user represented by User 2 node (e.g., following a user versus being connected to a user can represent different types of relationships between the user represented by User 3 node and the user represented by User 2 node); the user represented by the User 1 node has knowledge of topic 2 by virtue of Article 2 that is contained in the user's comment represented by the Comment U1 node; the user represented by the User 1 node has a skill represented by the Skill U11 node; and lastly the user represented by the User 1 node has a title represented by the Title U1 node.

In some implementations, combinations of nodes and edges are used to compute various scores, and those scores are used to, for example, generate user information. For example, a score that measures the affinity of the user represented by the User 1 node to the post represented by the Post U21 node can be computed using a path p1 that includes a sequence of edges between the nodes User 1 and Post U21 and/or a path p2 that includes a sequence of edges between the nodes User 1, Comment U1, and Post U21 and/or a path p3 that includes a sequence of edges between the nodes User 1, User 2, and Post U21 and/or a path p4 that includes a sequence of edges between the nodes User 1, User 3, Comment U1, Post U21. Any one or more of the paths p1, p2, p3, p4 and/or other paths through the graph 800 can be used to compute scores that represent affinities, relationships, or statistical correlations between different nodes. For instance, based on relative edge counts, a user-post affinity score computed between User U1 and Post U21, which might be predictive of the user's interest in the topic of the Post U21, might be higher than the user-post affinity score computed between User U4 and Post U21. Similarly, a user-skill affinity score computed between User 3 and Skill U31 might be higher than the user-skill affinity score computed between User 3 and Skill U11.

The examples shown in FIG. 8 and the accompanying description above are provided for illustration purposes. This disclosure is not limited to the described examples.

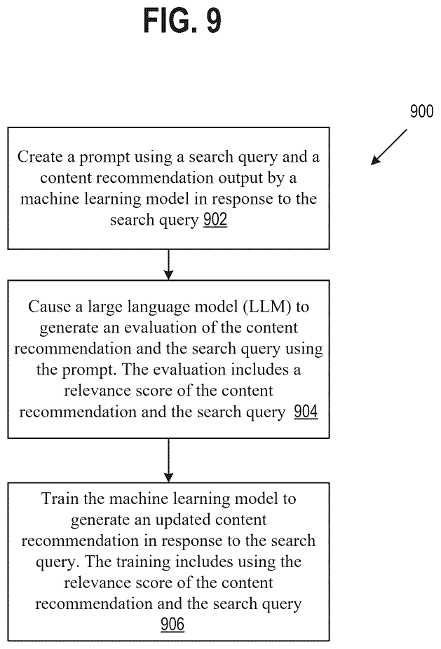

FIG. 9 is a flow diagram of an example method for evaluating content recommendations, in accordance with some embodiments of the present disclosure.

The method 900 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 900 is performed by one or more components of the content recommendation evaluator 136 of FIG. 1, the content recommendation evaluator 636 of FIG. 6, the training manager 430 described in FIG. 4 and/or some combination. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 902, a processing device creates a prompt using a search query and a content recommendation output by a machine learning model in response to the search query. In some implementations, the machine learning model can be a content recommendation engine trained to determine a ranking score associated with the content recommendation using the search query. Accordingly, the content recommendation engine can determine top k content recommendations based on the top k ranking scores associated with the content recommendations. In some implementations, the prompt includes the top k content recommendations associated with the top k ranking scores.

In some implementations, the search query is selected from a stable set of search queries updated at a first frequency. The static nature of the stable set of search queries, in terms of the type of search queries included in the test data set (e.g., static search queries) and/or in terms of the frequency of updates to the test data set (e.g., low frequency updates) ensures that the test data is stable. Accordingly, the stable set of search queries can serve as a safeguard against user configurations made to a machine learning mode that regress the performance of the machine learning model in terms of ranking one or more content recommendations (e.g., identifying high-quality content recommendations and low-quality content recommendations and ranking them accordingly).

In some implementations, the processing devices can create the prompt using a second search query and a second content recommendation output by the first machine learning model in response to the second search query. The second search query is selected from a dynamic set of search queries, and the dynamic set of search queries is updated at a second frequency higher than the first frequency. The dynamic nature of the dynamic set of search queries, in terms of the type of search queries included in the test data set (e.g., dynamic search queries) and/or in terms of the frequency of updated to the test data set (e.g., high frequency updates) ensures that the second search query (and other search queries obtained from the dynamic set of search queries) are relevant and reflective of current search query trends.

In some implementations, the prompt further includes user information of a user associated with the search query. For example, a search query can be tagged with user information associated with the user entering the search query. In some embodiments, the user information profile can include a user profile identifier (e.g., a number, a username, or an IP address), that links a user profile to a historic search query. User information can include the profile data 106A and entity connection data 106B described in FIG. 1.

At operation 904, the processing device causes a large language model (LLM) to generate an evaluation of the content recommendation and the search query using the prompt. The evaluation includes a relevance score (such as an OTR score) of the content recommendation and the search query.

In some implementations, the evaluation comprises a relevance score of the content recommendation and the search query based on the user information. That is, the relevance score represents whether the content recommendation is personalized and relevant to a user search intent.

In some implementations, the evaluation includes a reasoning for the relevance score. For example, the LLM can generate a natural language sentence that describes the LLM's reasoning for the relevance score.

At operation 908, the processing device trains the machine learning model to generate an updated content recommendation in response to the search query. The training includes using the relevance score of the content recommendation and the search query.

In some implementations, the processing device modifies a parameter of the machine learning model in response to the relevance score. For example, a parameter of the machine learning model can include one or more hyperparameters such as the number of layers in the machine learning model, the number of neurons in one or more layers of the machine learning model, the loss function used to train the machine learning model, one or more bias terms, one or more momentum terms, and/or or one or more inputs passed to the machine learning model.

In some implementations, the processing device combines the ranking score with the relevance score to generate an updated content recommendation. For example, the output of the machine learning model (e.g., the ranking score) associated with each content recommendation can be added with the relevance score. Modifying the output of the machine learning model is described in FIG. 3.

In some implementations, the processing device determines, using the machine learning model, the updated content recommendation using the search query and a feature, where the feature is based on the relevance score. For example, the input to the machine learning model can be modified to include a new input based on the relevance score. Modifying the input of the machine learning model is described in FIG. 3.

In some implementations, the processing device creates a second prompt using the search query and a second content recommendation output by a second machine learning model in response to the search query. The second machine learning model can be a machine learning model that is different from the first machine learning model in terms of how the second machine learning model is trained, the training data used to train the second machine learning model, the parameters of the second machine learning model (e.g., number of layers, nodes, a momentum term, a bias term), the inputs to the second machine learning model, the outputs determined by the machine learning model, and/or the architecture of the machine learning model. Accordingly, the second content recommendation can be a different content recommendation than the first content recommendation.

The LLM generates a second evaluation of the second content recommendation and the search query using the second prompt. The evaluation can include a second relevance score of the second content recommendation and the search query (e.g., an OTR score associated with the second content recommendation).

The processing device can provide a comparison of the first relevance score and the second relevance score to a computing device. For example, as described with reference to FIG. 6, the quality of a benchmark recommendation engine (e.g., the second machine learning model) can be compared to the quality of a test recommendation engine (e.g., the first machine learning model) based on the OTR scores associated with content recommendations. Accordingly as described with reference to FIG. 6, the recommendation engine results 654 can be provided to user system 610.

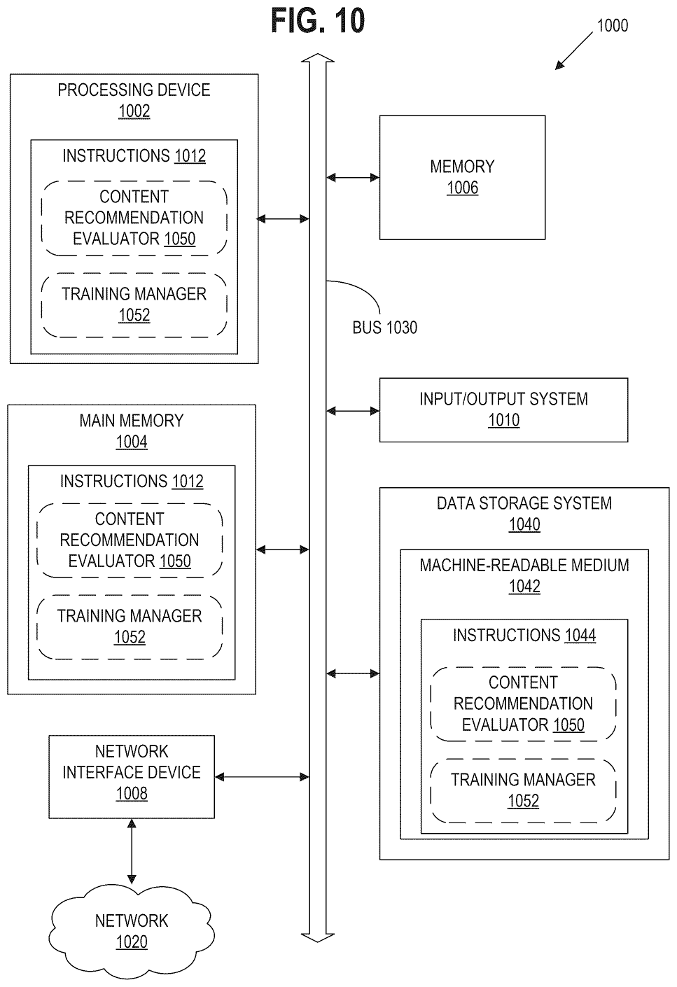

FIG. 10 is a block diagram of an example computer system including a content recommendation evaluator and a training manager, in accordance with some embodiments of the present disclosure.

In FIG. 10, an example machine of a computer system 1000 is shown, within which a set of instructions for causing the machine to perform any of the methodologies discussed herein can be executed. In some embodiments, the computer system 1000 can correspond to a component of a networked computer system (e.g., as a component of the content recommendation evaluator 136 of FIG. 1, the content recommendation evaluator 636 of FIG. 6, the training manager 430 of FIG. 4, or the application software system 730 of FIG. 7) that includes, is coupled to, or utilizes a machine to execute an operating system to perform operations corresponding to one or more components of the content recommendation evaluator 136 of FIG. 1, the content recommendation evaluator 636 of FIG. 6, the training manager 430 of FIG. 4, or the application software system 730 of FIG. 7. For example, computer system 1000 corresponds to a portion of computing system when the computing system is executing a portion of the content recommendation evaluator 136 of FIG. 1, the content recommendation evaluator 636 of FIG. 6, the training manager 430 of FIG. 4, or the application software system 730 of FIG. 7.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1000 includes a processing device 1002, a main memory 1004 (e.g., read-only memory (ROM), flash memory, dynamic random access memory (DRAM) such as synchronous DRAM (SDRAM) or Rambus DRAM (RDRAM), etc.), a memory 1003 (e.g., flash memory, static random access memory (SRAM), etc.), an input/output system 1010, and a data storage system 1040, which communicate with each other via a bus 1030.

Processing device 1002 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 can also be at least one special-purpose processing device such as an application specific integrated circuit (ASIC), a field programmable gate array (FPGA), a digital signal processor (DSP), network processor, or the like. The processing device 1002 is configured to execute instructions 1012 for performing the operations and steps discussed herein.

In some embodiments of FIG. 10, the content recommendation evaluator 1050 represents portions of the content recommendation evaluator 136 of FIG. 1, the content recommendation evaluator 636 of FIG. 6, or the application software system 730 of FIG. 7 when the computer system 1000 is executing those portions of content recommendation evaluator 1050. The training manager 1052 represents portions of the training manager 430 of FIG. 4 or the application software system 730 of FIG. 7 when the computer system 1000 is executing those portions of the training manager 1052. Instructions 1012 include portions of content recommendation evaluator 1050 when those portions of the content recommendation evaluator 1050 are being executed by processing device 1002. Instructions 1012 may also include portions of the training manager 1052 when those portions of the training manager 1052 are being executed by processing device 1002. Thus, both the content recommendation evaluator 1050 and training manager 1052 are shown in dashed lines as part of instructions 1012 to illustrate that, at times, portions of the content recommendation evaluator 1050 and training manager 1052 are executed by processing device 1002. For example, when at least some portion of the content recommendation evaluator 1050 or training manager 1052 is embodied in instructions to cause processing device 1002 to perform the method(s) described herein, some of those instructions can be read into processing device 1002 (e.g., into an internal cache or other memory) from main memory 1004 and/or data storage system 1040. However, it is not required that all of the content recommendation evaluator 1050 and/or training manager 1052 be included in instructions 1012 at the same time and portions of the content recommendation evaluator 1050 and/or training manager 1052 are stored in at least one other component of computer system 1000 at other times, e.g., when at least one portion of the content recommendation evaluator 1050 and/or training manager 1052 is not being executed by processing device 1002.

The computer system 1000 further includes a network interface device 1008 to communicate over the network 1020. Network interface device 1008 provides a two-way data communication coupling to a network. For example, network interface device 1008 can be an integrated-services digital network (ISDN) card, cable modem, satellite modem, or a modem to provide a data communication connection to a corresponding type of telephone line. As another example, network interface device 1008 can be a local area network (LAN) card to provide a data communication connection to a compatible LAN. Wireless links can also be implemented. In any such implementation network interface device 1008 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 1000.

Computer system 1000 can send messages and receive data, including program code, through the network(s) and network interface device 1008. In the Internet example, a server can transmit a requested code for an application program through the Internet and network interface device 1008. The received code can be executed by processing device 1002 as it is received, and/or stored in data storage system 1040, or other non-volatile storage for later execution.

The input/output system 1010 includes an output device, such as a display, for example a liquid crystal display (LCD) or a touchscreen display, for displaying information to a computer user, or a speaker, a haptic device, or another form of output device. The input/output system 1010 can include an input device, for example, alphanumeric keys and other keys configured for communicating information and command selections to processing device 1002. An input device can, alternatively or in addition, include a cursor control, such as a mouse, a trackball, or cursor direction keys for communicating direction information and command selections to processing device 1002 and for controlling cursor movement on a display. An input device can, alternatively or in addition, include a microphone, a sensor, or an array of sensors, for communicating sensed information to processing device 1002. Sensed information can include voice commands, audio signals, geographic location information, haptic information, and/or digital imagery, for example.

The data storage system 1040 includes a machine-readable storage medium 1042 (also known as a computer-readable medium) on which is stored at least one set of instructions 1044 or software embodying any of the methodologies or functions described herein. The instructions 1044 can also reside, completely or at least partially, within the main memory 1004 and/or within the processing device 1002 during execution thereof by the computer system 1000, the main memory 1004 and the processing device 1002 also constituting machine-readable storage media. In one embodiment, the instructions 1044 include instructions to implement functionality corresponding to the content recommendation evaluator 136 of FIG. 1, the content recommendation evaluator 636 of FIG. 6, the training manager 430 of FIG. 4, or the application software system 730 of FIG. 7.

Dashed lines are used in FIG. 10 to indicate that it is not required that the content recommendation evaluator 1050 and/or the training manager 1052 be embodied entirely in instructions 1012, 1014, and 1044 at the same time. In one example, portions of content recommendation evaluator 1050 and/or the training manager 1052 are embodied in instructions 1014, which are read into main memory 1004 as instructions 1014, and portions of instructions 1012 are read into processing device 1002 as instructions 1012 for execution. In another example, some portions of the content recommendation evaluator 1050 and/or the training manager 1052 are embodied in instructions 1044 while other portions are embodied in instructions 1014 and still other portions are embodied in instructions 1012.

While the machine-readable storage medium 1042 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 10 and the accompanying description above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 600, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Illustrative examples of the technologies disclosed herein are provided below. An embodiment of the technologies may include any of the examples described herein, or any combination of any of the examples described herein, or any combination of any portions of the examples described herein.

In some aspects, the techniques described herein relate to a method including: creating a prompt using a search query and a content recommendation output by a machine learning model in response to the search query; causing a large language model (LLM) to generate an evaluation of the content recommendation and the search query using the prompt, wherein the evaluation includes a relevance score of the content recommendation and the search query; and training the machine learning model to generate an updated content recommendation in response to the search query, wherein the training includes using the relevance score of the content recommendation and the search query.

In some aspects, the techniques described herein relate to a method, wherein the prompt further includes user information of a user associated with the search query.

In some aspects, the techniques described herein relate to a method, wherein the evaluation includes a relevance score of the content recommendation and the search query based on the user information.

In some aspects, the techniques described herein relate to a method, wherein the search query is selected from a stable set of search queries, and the stable set of search queries is updated at a first frequency.

In some aspects, the techniques described herein relate to a method, wherein the content recommendation is a first content recommendation, the search query is a first search query, the machine learning model is a first machine learning model, and the evaluation is a first evaluation, further including: creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

In some aspects, the techniques described herein relate to a method, further including: modifying a parameter of the machine learning model in response to the relevance score.

In some aspects, the techniques described herein relate to a method, wherein the content recommendation is a first content recommendation, the evaluation is a first evaluation, and the relevance score is a first relevance score, further including: creating a second prompt using the search query and a second content recommendation output by a second machine learning model in response to the search query; causing the LLM to generate a second evaluation of the second content recommendation and the search query using the second prompt, wherein the evaluation includes a second relevance score of the second content recommendation and the search query; and providing, to a computing device, a comparison of the first relevance score and the second relevance score.

In some aspects, the techniques described herein relate to a method, wherein the evaluation includes a reasoning for the relevance score.

In some aspects, the techniques described herein relate to a method, further including: generating, by the machine learning model, a ranking score associated with the content recommendation using the search query.

In some aspects, the techniques described herein relate to a method, wherein training the machine learning model to generate the updated content recommendation further includes: combining the ranking score with the relevance score to generate the updated content recommendation.

In some aspects, the techniques described herein relate to a method, wherein training the machine learning model to generate the updated content recommendation further includes: determining, by the machine learning model, the updated content recommendation using the search query and a feature, wherein the feature is based on the relevance score.

In some aspects, the techniques described herein relate to a system including: at least one processor; and at least one memory device coupled to the at least one processor, wherein the at least one memory device includes instructions that, when executed by the at least one processor, cause the at least one processor to perform at least one operation including: creating a prompt using a search query and a content recommendation output by a machine learning model in response to the search query; causing a large language model (LLM) to generate an evaluation of the content recommendation and the search query using the prompt, wherein the evaluation includes a relevance score of the content recommendation and the search query; and training the machine learning model to generate an updated content recommendation in response to the search query, wherein the training includes using the relevance score of the content recommendation and the search query.

In some aspects, the techniques described herein relate to a system, wherein the search query is selected from a stable set of search queries, and the stable set of search queries is updated at a first frequency.

In some aspects, the techniques described herein relate to a system, wherein the content recommendation is a first content recommendation, the search query is a first search query, the machine learning model is a first machine learning model, and the evaluation is a first evaluation and wherein the instructions, when executed by the at least one processor, cause the at least one processor to perform at least one operation further including: creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

In some aspects, the techniques described herein relate to a system, wherein the instructions, when executed by the at least one processor, cause the at least one processor to perform at least one operation further including: modifying a parameter of the machine learning model in response to the relevance score.

In some aspects, the techniques described herein relate to a non-transitory machine-readable storage medium including instructions that, when executed by at least one processor, cause the at least one processor to perform at least one operation including: creating a prompt using a search query and a content recommendation output by a machine learning model in response to the search query; causing a large language model (LLM) to generate an evaluation of the content recommendation and the search query using the prompt, wherein the evaluation includes a relevance score of the content recommendation and the search query; and training the machine learning model to generate an updated content recommendation in response to the search query, wherein the training includes using the relevance score of the content recommendation and the search query.

In some aspects, the techniques described herein relate to a non-transitory machine-readable storage medium, wherein the search query is selected from a stable set of search queries, and the stable set of search queries is updated at a first frequency.

In some aspects, the techniques described herein relate to a non-transitory machine-readable storage medium, wherein the content recommendation is a first content recommendation, the search query is a first search query, the machine learning model is a first machine learning model, and the evaluation is a first evaluation and wherein the instructions, when executed by the at least one processor, cause the at least one processor to perform at least one operation further including: creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

In some aspects, the techniques described herein relate to a non-transitory machine-readable storage medium, wherein the instructions, when executed by the at least one processor, cause the at least one processor to perform at least one operation further including: modifying a parameter of the machine learning model in response to the relevance score.

In some aspects, the techniques described herein relate to a non-transitory machine-readable storage medium, wherein the evaluation includes a reasoning for the relevance score.

Clause 1. A method comprising: creating a prompt using a search query and a content recommendation output by a machine learning model in response to the search query; causing a large language model (LLM) to generate an evaluation of the content recommendation and the search query using the prompt, wherein the evaluation comprises a relevance score of the content recommendation and the search query; and training the machine learning model to generate an updated content recommendation in response to the search query, wherein the training comprises using the relevance score of the content recommendation and the search query.

Clause 2. The method of clause 1, wherein the prompt further comprises user information of a user associated with the search query.

Clause 3. The method of clause 1 or clause 2, wherein the evaluation comprises a relevance score of the content recommendation and the search query based on the user information.

Clause 4. The method of any clauses 1-3, wherein the search query is selected from a stable set of search queries, and the stable set of search queries is updated at a first frequency.

Clause 5. The method of any clauses 1-4, wherein the content recommendation is a first content recommendation, the search query is a first search query, the machine learning model is a first machine learning model, and the evaluation is a first evaluation, further comprising: creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

Clause 6. The method of any clauses 1-5, further comprising: modifying a parameter of the machine learning model in response to the relevance score.

Clause 7. The method of any clauses 1-6, wherein the content recommendation is a first content recommendation, the evaluation is a first evaluation, and the relevance score is a first relevance score, further comprising: creating a second prompt using the search query and a second content recommendation output by a second machine learning model in response to the search query; causing the LLM to generate a second evaluation of the second content recommendation and the search query using the second prompt, wherein the evaluation comprises a second relevance score of the second content recommendation and the search query; and providing, to a computing device, a comparison of the first relevance score and the second relevance score.

Clause 8. The method of any clauses 1-7, wherein the evaluation comprises a reasoning for the relevance score.

Clause 9. The method of any clauses 1-8, further comprising: generating, by the machine learning model, a ranking score associated with the content recommendation using the search query.

Clause 10. The method of any clauses 1-9, wherein training the machine learning model to generate the updated content recommendation further comprises: combining the ranking score with the relevance score to generate the updated content recommendation.

Clause 11. The method of any clauses 1-10, wherein training the machine learning model to generate the updated content recommendation further comprises: determining, by the machine learning model, the updated content recommendation using the search query and a feature, wherein the feature is based on the relevance score.

Clause 12. A system comprising: at least one processor; and at least one memory device coupled to the at least one processor, wherein the at least one memory device comprises instructions that, when executed by the at least one processor, cause the at least one processor to perform at least one operation comprising: creating a prompt using a search query and a content recommendation output by a machine learning model in response to the search query; causing a large language model (LLM) to generate an evaluation of the content recommendation and the search query using the prompt, wherein the evaluation comprises a relevance score of the content recommendation and the search query; and training the machine learning model to generate an updated content recommendation in response to the search query, wherein the training comprises using the relevance score of the content recommendation and the search query.

Clause 13. The system of clause 12, wherein the search query is selected from a stable set of search queries, and the stable set of search queries is updated at a first frequency.

Clause 14. The system of clause 13 or clause 12, wherein the content recommendation is a first content recommendation, the search query is a first search query, the machine learning model is a first machine learning model, and the evaluation is a first evaluation and wherein the instructions, when executed by the at least one processor, cause the at least one processor to perform at least one operation further comprising: creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

Clause 15. The system of any clauses 12-14, wherein the instructions, when executed by the at least one processor, cause the at least one processor to perform at least one operation further comprising: modifying a parameter of the machine learning model in response to the relevance score.

Clause 16. A non-transitory machine-readable storage medium comprising instructions that, when executed by at least one processor, cause the at least one processor to perform at least one operation comprising: creating a prompt using a search query and a content recommendation output by a machine learning model in response to the search query; causing a large language model (LLM) to generate an evaluation of the content recommendation and the search query using the prompt, wherein the evaluation comprises a relevance score of the content recommendation and the search query; and training the machine learning model to generate an updated content recommendation in response to the search query, wherein the training comprises using the relevance score of the content recommendation and the search query.

Clause 17. The non-transitory machine-readable storage medium of clause 16, wherein the search query is selected from a stable set of search queries, and the stable set of search queries is updated at a first frequency.

Clause 18. The non-transitory machine-readable storage medium of clause 17 or clause 16, wherein the content recommendation is a first content recommendation, the search query is a first search query, the machine learning model is a first machine learning model, and the evaluation is a first evaluation and wherein the instructions, when executed by the at least one processor, cause the at least one processor to perform at least one operation further comprising: creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

Clause 19. The non-transitory machine-readable storage medium of any clauses 16-18, wherein the instructions, when executed by the at least one processor, cause the at least one processor to perform at least one operation further comprising: modifying a parameter of the machine learning model in response to the relevance score.

Clause 20. The non-transitory machine-readable storage medium of any clauses 16-19, wherein the evaluation comprises a reasoning for the relevance score.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
creating a prompt using a search query and a content recommendation output by a machine learning model in response to the search query;
causing a large language model (LLM) to generate an evaluation of the content recommendation and the search query using the prompt, wherein the evaluation comprises a relevance score of the content recommendation and the search query; and
training the machine learning model to generate an updated content recommendation in response to the search query, wherein the training comprises using the relevance score of the content recommendation and the search query.

2. The method of claim 1, wherein the prompt further comprises user information of a user associated with the search query.

3. The method of claim 2, wherein the evaluation comprises a relevance score of the content recommendation and the search query based on the user information.

4. The method of claim 1, wherein the search query is selected from a stable set of search queries, and the stable set of search queries is updated at a first frequency.

5. The method of claim 4, wherein the content recommendation is a first content recommendation, the search query is a first search query, the machine learning model is a first machine learning model, and the evaluation is a first evaluation, further comprising:
creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

6. The method of claim 1, further comprising:
modifying a parameter of the machine learning model in response to the relevance score.

7. The method of claim 1, wherein the content recommendation is a first content recommendation, the evaluation is a first evaluation, and the relevance score is a first relevance score, further comprising:
creating a second prompt using the search query and a second content recommendation output by a second machine learning model in response to the search query;
causing the LLM to generate a second evaluation of the second content recommendation and the search query using the second prompt, wherein the evaluation comprises a second relevance score of the second content recommendation and the search query; and
providing, to a computing device, a comparison of the first relevance score and the second relevance score.

8. The method of claim 1, wherein the evaluation comprises a reasoning for the relevance score.

9. The method of claim 1, further comprising:
generating, by the machine learning model, a ranking score associated with the content recommendation using the search query.

10. The method of claim 9, wherein training the machine learning model to generate the updated content recommendation further comprises:
combining the ranking score with the relevance score to generate the updated content recommendation.

11. The method of claim 1, wherein training the machine learning model to generate the updated content recommendation further comprises:
determining, by the machine learning model, the updated content recommendation using the search query and a feature, wherein the feature is based on the relevance score.

12. A system comprising:
at least one processor; and
at least one memory device coupled to the at least one processor, wherein the at least one memory device comprises instructions that, when executed by the at least one processor, cause the at least one processor to perform at least one operation comprising:
creating a prompt using a search query and a content recommendation output by a machine learning model in response to the search query;
causing a large language model (LLM) to generate an evaluation of the content recommendation and the search query using the prompt, wherein the evaluation comprises a relevance score of the content recommendation and the search query; and
training the machine learning model to generate an updated content recommendation in response to the search query, wherein the training comprises using the relevance score of the content recommendation and the search query.

13. The system of claim 12, wherein the search query is selected from a stable set of search queries, and the stable set of search queries is updated at a first frequency.

14. The system of claim 13, wherein the content recommendation is a first content recommendation, the search query is a first search query, the machine learning model is a first machine learning model, and the evaluation is a first evaluation and wherein the instructions, when executed by the at least one processor, cause the at least one processor to perform at least one operation further comprising:
creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

15. The system of claim 12, wherein the instructions, when executed by the at least one processor, cause the at least one processor to perform at least one operation further comprising:
modifying a parameter of the machine learning model in response to the relevance score.

16. A non-transitory machine-readable storage medium comprising instructions that, when executed by at least one processor, cause the at least one processor to perform at least one operation comprising:
creating a prompt using a search query and a content recommendation output by a machine learning model in response to the search query;
causing a large language model (LLM) to generate an evaluation of the content recommendation and the search query using the prompt, wherein the evaluation comprises a relevance score of the content recommendation and the search query; and
training the machine learning model to generate an updated content recommendation in response to the search query, wherein the training comprises using the relevance score of the content recommendation and the search query.

17. The non-transitory machine-readable storage medium of claim 16, wherein the search query is selected from a stable set of search queries, and the stable set of search queries is updated at a first frequency.

18. The non-transitory machine-readable storage medium of claim 17, wherein the content recommendation is a first content recommendation, the search query is a first search query, the machine learning model is a first machine learning model, and the evaluation is a first evaluation and wherein the instructions, when executed by the at least one processor, cause the at least one processor to perform at least one operation further comprising:
creating the prompt using a second search query and a second content recommendation output by the first machine learning model in response to the second search query, wherein the second search query is selected from a dynamic set of search queries, and the dynamic set of search queries is updated at a second frequency, the second frequency being higher than the first frequency.

19. The non-transitory machine-readable storage medium of claim 16, wherein the instructions, when executed by the at least one processor, cause the at least one processor to perform at least one operation further comprising:
modifying a parameter of the machine learning model in response to the relevance score.

20. The non-transitory machine-readable storage medium of claim 16, wherein the evaluation comprises a reasoning for the relevance score.
